(19) United States
(12) Patent Application Publication
(10) Pub. No.: US 2013/0066772 A1
(43) Pub. Date: Mar. 14, 2013

(54) MULTI-FACTOR AND MULTI-CHANNEL ID AUTHENTICATION AND TRANSACTION CONTROL AND MULTI-OPTION PAYMENT SYSTEM AND METHOD

(71) Applicant: Chuyu XIONG, Jericho, NY (US)

(72) Inventor: Chuyu XIONG, Jericho, NY (US)

(21) Appl. No.: 13/606,352

(22) Filed: Sep. 7, 2012

Related U.S. Application Data
(63) Continuation-in-part of application No. 13/229,219, filed on Sep. 9, 2011.
(60) Provisional application No. 61/544,800, filed on Oct. 7, 2011.

(51) Int. Cl. G06Q 40/00

(52) U.S. Cl. 705/39

(57) ABSTRACT

The present disclosure provides a multi-option system and method for payment of selected item from a merchant. A purchaser selects a payment option through an electronic device. A payment message indicating the selected payment option and the purchaser's account information associated with the selected payment option is sent to a payment portal. The payment portal selects a suitable participating entity based on the selected payment option and sends the purchaser's account information to the selected participating entity. The participating entity authenticates the purchaser's account and generates an instruction message based on the result of the authentication. The portal receives the instruction message and sends the same to a server of the merchant.

### CROSS REFERENCE TO RELATED APPLICATIONS

This application is related to and claims the benefits of U.S. Provisional Patent Application Ser. No. 61/544,800 filed Oct. 7, 2011 and U.S. patent application Ser. No. 13/229,219 filed Sep. 9, 2011, the entire contents of which are incorporated by reference herein.

### FIELD OF THE DISCLOSURE

The present disclosure generally relates to the field of identification (ID) authentication and transaction control used during electronic payment, and electronic payment system and method. More particularly, the disclosure relates to a multi-factor and multi-channel ID authentication and transaction control system and an electronic payment system and method for a secure, multi-channel and multi-option payment.

### BACKGROUND

In modern society, ID authentication and transaction control are common and indispensable for commerce, particularly commerce on a global scale. Most ID authentication and transaction control is conducted based on a single factor and a single channel. The factor can be any authentication factor, such as what a person has, e.g. a token, what a person knows, e.g. a password, what a person is, e.g. a fingerprint, or what a person is related to, e.g. a social network, and the like. The channel can be any information communication channel, such as Internet, telephones, specialized network and the like.

ID authentication and transaction control based on a single factor and a single channel is considered vulnerable to attacks, one form of which is commonly known as Man-In-The-Middle (MITM) attack. In an MITM attack, a fraudster uses a device connected to a client and an application server, by relaying requests and answers, to steal data and/or to act on behalf of the client browser to accomplish fraudulent purposes.

Furthermore, with the fast growth of global commerce, it is imperative for an ID authentication and transaction control system to handle multiple IDs for a single user in an easy and flexible manner. Nowadays, consumers often have multiple IDs including passports, driver's licenses, email accounts, working place IDs, credit cards, bank accounts, entertainment accounts, social network accounts, consumer accounts and the like. It is the consumers' right to have multiple IDs and to select a proper ID under different circumstances, while keeping the IDs confidential. However, the existing ID authentication and transaction control scheme requires centralization of ID authentication and transaction control, which in fact deprives the consumers' right to maintain and control her/his own multiple IDs.

In addition, it is burdensome for a consumer to handle multiple IDs, particularly when these IDs and associated passwords need to be changed frequently for safety purposes. Also, during transaction, third party control is not desired by service providers, who typically wish to maintain a full control and management of the transaction. Moreover, under certain circumstances, consumers do not wish to associate their actions with their unique identifications. Accordingly, remaining anonymous during transaction is also desired by users.

Therefore, the applicant has recognized that it is desirable to develop a multi-factor and multi-channel ID authentication and transaction control system and method, which is capable of supporting commerce on a global scale without requiring a centralized station, reducing user's burdens for memorizing IDs and passwords, providing full control and management to service providers, and maintaining anonymous of consumers during certain transactions.

Traditional electronic payment systems require that purchasers' account information be saved at a payment portal. The payment portal receives payment instructions from the purchasers and validates the purchasers' account according to the saved account information. Typically, only one payment option associated with the previously saved account information is available to the purchasers. Thus, the existing electronic payment systems do not allow the purchasers to select a suitable payment option from a plurality of available payment options. Further, permanently saving the purchasers' account information in the payment portal raises security and privacy concerns.

Therefore, the applicant has recognized that it is desirable to develop an electronic payment system and method, which provides a plurality of payment options to the purchasers and which does not require saving the purchasers' account information at a payment portal.

### SUMMARY

According to one aspect of the present disclosure is provided a method of allowing a purchaser to use an electronic device to execute the payment of a selected item from a merchant. The method includes receiving a code representative of transaction-related information associated with the selected item, retrieving the transaction-related information from the code, validating the transaction-related information, selecting at least one payment option from a plurality of predetermined payment options, generating a payment message based on the transaction-related information and the payment option, and sending the payment message to a payment portal in communication with a plurality of participating entities. The payment message includes a first segment indicating the payment option and a second segment indicating the purchaser's account data associated with the payment option. Each of the participating entities is associated with at least one of the plurality of predetermined payment options.

According to another aspect of the present disclosure is provided a method of allowing a purchaser to execute the payment of a selected item from a merchant through a payment portal in communication with a plurality of participating entities, each participating entity associated with at least one of a plurality of predetermined payment options. The method includes receiving a payment message comprising a first segment indicating a payment option selected by the purchaser from the plurality of predetermined payment options and a second segment indicating the purchaser's account data associated with the selected payment option, selecting a participating entity associated with the selected payment option based on the first segment of the payment message, sending the second segment of the payment message to the selected participating entity for validating the purchaser's account associated with the selected payment option, receiving an instruction message from the selected participating entity, the instruction message generated based on the validity of the purchaser's account, and sending the instruction message to a server of the merchant.

According to another aspect of the present disclosure is provided a computer program product for use with a computer, the computer program product comprising a computer readable storage medium having recorded thereon a computer-executable program for causing the computer to perform a process of allowing a purchaser to use an electronic device to execute the payment of a selected item from a merchant. The process includes receiving a code representative of transaction-related information associated with the selected item, retrieving the transaction-related information from the code, validating the transaction-related information, selecting at least one payment option from a plurality of predetermined payment options, generating a payment message based on the transaction-related information and the payment option, and sending the payment message to a payment portal in communication with a plurality of participating entities. The payment message includes a first segment indicating the payment option and a second segment indicating the purchaser's account data associated with the payment option. Each of the participating entities is associated with at least one of the plurality of predetermined payment options.

According to another aspect of the present disclosure is provided a data processing system for allowing a purchaser to use an electronic device to execute the payment of a selected item from a merchant. The system includes a transceiver configured to receive a code representative of transaction-related information associated with the selected item, a processor configured to retrieve the transaction-related information from the code, a display configured to display the transaction-related information, such that the transaction-related information can be validated by the purchaser, and a user interface configured to allow the purchaser to select a payment option from a plurality of predetermined payment options. The processor is further configured to generate a payment message based on the transaction-related information and the payment option. The payment message includes a first segment indicating the payment option and a second segment indicating the purchaser's account data associated with the payment option. The transceiver is further configured to send the payment message to a payment portal in communication with a plurality of participating entities, each of said participating entities being associated with at least one of the plurality of predetermined payment options.

According to another aspect of the present disclosure is provided a computer program product for use with a computer, the computer program product comprising a computer readable storage medium having recorded thereon a computer-executable program for causing the computer to perform a process of allowing a purchaser to execute the payment of a selected item from a merchant through a portal in communication with a plurality of participating entities, each participating entity associated with at least one of a plurality of predetermined payment options. The process includes receiving a payment message comprising a first segment indicating a payment option selected by the purchaser from the plurality of predetermined payment options and a second segment indicating the purchaser's account data associated with the selected payment option, selecting a participating entity associated with the selected payment option based on the first segment of the payment message, sending the second segment of the payment message to the selected participating entity for validating the purchaser's account associated with the selected payment option, receiving an instruction message from the selected participating entity, the instruction message generated based on the validity of the purchaser's account, and sending the instruction message to a server of the merchant.

According to another aspect of the present disclosure is provided a data processing system for allowing a purchaser to execute the payment of a selected item from a merchant through a portal in communication with a plurality of participating entities, each participating entity associated with at least one of a plurality of predetermined payment options. The system includes a transceiver configured to receive a payment message comprising a first segment indicating a payment option selected by the purchaser and a second segment indicating the purchaser's account data associated with the selected payment option, and a processor configured to select a participating entity associated with the selected payment option based on the first segment of the payment message. The transceiver is further configured to send the second segment of the payment message to the selected participating entity for validating the purchaser's account, receive an instruction message generated based on the validity of the purchaser's account from the selected participating entity, and send the instruction message to a server of the merchant.

### BRIEF DESCRIPTION OF THE DRAWINGS

The foregoing objects and advantages of the present disclosure may be more readily understood by one skilled in the art with reference to the following detailed description of several embodiments thereof, taken in conjunction with the accompanying drawings wherein like elements are designated by identical reference numerals throughout the several views, and in which:

FIGS. 1A-1D are views of several designs of a handheld electronic authenticator;

FIG. 2 is a block diagram of the logical design of the handheld electronic authenticator according to an embodiment of the present disclosure;

FIG. 3 is a block diagram of the read protected memory 255 and the RAM 265 in the memory system of the computing module 205 in FIG. 2;

FIG. 4 is a block diagram of the logical design of a foil of the handheld electronic authenticator according to an embodiment of the present disclosure;

FIG. 5 is a flowchart of a process of initiation/maintenance of the handheld electronic authenticator according to an embodiment of the disclosure;

FIG. 6 is a flowchart of a detailed process of initiation/maintenance that takes place in the server of authenticator;

FIG. 7 is a flowchart of a process of initiation/maintenance of a foil of the handheld electronic authenticator according to a preferred embodiment of the present disclosure;

FIG. 8 is a flowchart of a detailed process of initiation/maintenance that takes place in the server of service provider;

FIG. 9 is a flowchart of a process of identification authentication according to an embodiment of the present disclosure;

FIG. 10 is a flowchart of the detailed process of identification authentication;

FIG. 11 is a continued flowchart of the detailed process of identification authentication of FIG. 10;

FIG. 12 is a continued flowchart of the detailed process of identification authentication of FIG. 11;

FIG. 13 is flowchart of a process of signature generation according to an embodiment of the present disclosure;

FIG. 14 is a flowchart of a process using the handheld electronic authenticator to request service from service provider;

FIG. 15 is a flowchart of a process using the handheld electronic authenticator in a transaction with a 3rd party;

FIG. 16 is a flow chart of a process using the handheld electronic authenticator in a transaction with more data required by the service provider;

FIG. 17 is a block diagram showing a multi-factor and multi-channel ID authentication and transaction control system according to an embodiment of the disclosure;

FIGS. 18A-18D are schematic diagrams illustrating communication between a handheld electronic device and a terminal of the multi-factor and multi-channel ID authentication and transaction control system;

FIGS. 19A-19B are schematic diagrams illustrating communication between the handheld electronic device and a server of a service provider;

FIG. 20 is a schematic diagram illustrating communication between the terminal and servers of service providers;

FIG. 21 is a schematic diagram illustrating communication between a server of the device and servers of service providers;

FIG. 22 is a schematic diagram illustrating a personalization process of the device;

FIG. 23 is a schematic diagram illustrating a binding process, in which the device and the server of the service provider are associated to allow the device and the server to share one or more symmetric keys;

FIG. 23A is a schematic diagram illustrating a process for obtaining a one-time anonymous name from a server of the device during the binding process;

FIG. 24 is a schematic diagram illustrating a process of ID authentication;

FIG. 25 is a schematic diagram illustrating a process of transaction control;

FIG. 26 is a schematic diagram illustrating a process of unbinding the device from the service providers;

FIG. 27 is a schematic diagram illustrating a process of rebinding the device with one or more service providers;

FIG. 28 is a schematic diagram illustrating a data processing system used in connection with the device for multi-factor and multi-channel ID authenticating and controlling;

FIG. 29 is a schematic diagram illustrating a data processing system used in connection with a server of the service provider for multi-factor and multi-channel ID authenticating and controlling;

FIG. 30 is a block diagram showing a payment system according to an embodiment of the disclosure;

FIG. 31 is a flowchart showing a method of allowing a purchaser to use an electronic device to execute the payment of a selected item from a merchant according to another embodiment of the disclosure; and

FIG. 32 is a flowchart showing a method of allowing a purchaser to execute the payment of a selected item from a merchant through a payment portal in communication with multiple participating entities according to another embodiment of the disclosure.

### DETAILED DESCRIPTION OF EMBODIMENTS

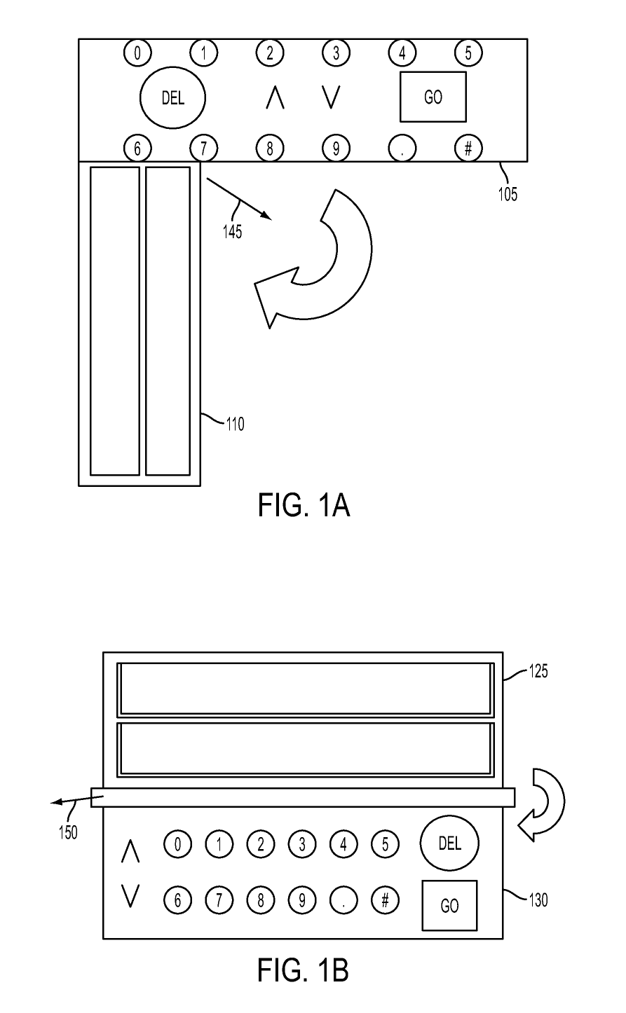

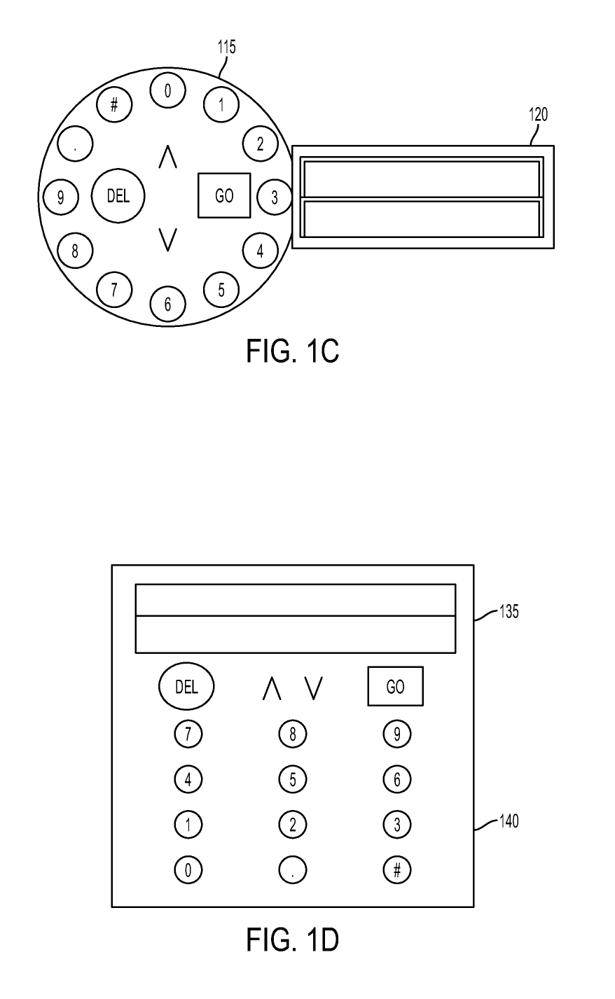

FIGS. 1A-1D are views of several designs of the handheld electronic authenticator. Referring to FIGS. 1A-1D, each design of the authenticator provides has a keypad (i.e. 105, 115, 130 and 140) having a plurality of keys receiving user inputs. The authenticators also have display units made of liquid crystal display (LCD) (i.e. 110, 120, 125 and 135). The unique features of the designs are as follows. Referring to FIG. 1A, the keypad 105 and the display unit 110 are rotatable around a common center point 145. In FIG. 1B, the authenticator is foldable along a lengthwise hinge 150 connecting the keypad unit 130 and the display unit 125. In FIG. 1C, the keypad 115 and the display unit 120 are made in one piece with a shape of a traditional key. In FIG. 1D, the authenticator takes a rectangular shape resembling a calculator.

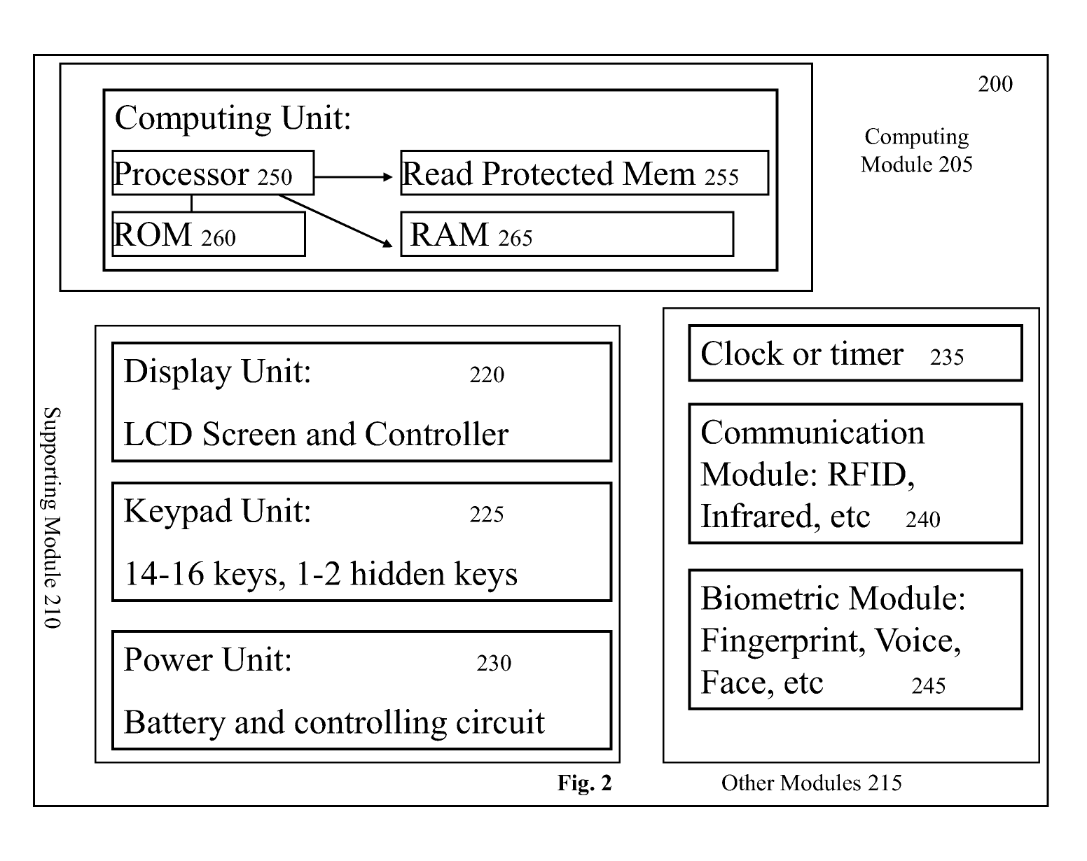

FIG. 2 is a block diagram of the logical design of the handheld electronic authenticator according to an embodiment of the present disclosure. Referring to FIG. 2, the authenticator includes a computing module 205, a supporting module 210 and other modules 215.

The computing module 205 contains a computing unit including a processor 250 for computing the authentication codes and a memory system for storing various data of the authenticator. The memory system includes a read/write protected memory 255 that protects the data from outside intrusion; a read-only memory (ROM) 260 storing static data; and a random access memory (RAM) 265 storing dynamic data generated in the process of authenticating. In addition to computing the various authentication codes, the computing module 205 executes other computational activities of the authenticator such as executing instructions, decrypting messages, etc., which will be described in more detail below.

The supporting module 210 provides support to the computing unit 205 in inputting/outputting data, supplying powers and other assistance for the authenticator to function properly. The supporting module 210 includes a display unit 220, e.g. an LCD screen and a controller therein for displaying data on the display unit 220; a keypad unit 225, e.g. a keypad having 14-18 keys and 1-2 hidden keys for inputting data; and a power unit that contains a battery and controlling circuit thereof.

Other modules 215 provide other functions that may be added to the authenticator. A clock or timer 235 provides a time keeping function. A communication module 240 provides transmission capacity to external devices based on communication technologies such as the radio frequency identification (RFID) or infrared technology. A biometric module 245 takes the biometrics of a user as inputs, such as a user's fingerprints, voice or facial features in combination with the authentication codes as an additional factor taken into consideration in the process of authenticating. The authenticator is extendable in that more functions can be added to the other modules 215. The modules may be implemented as hardware, software, or firmware components on the authenticator.

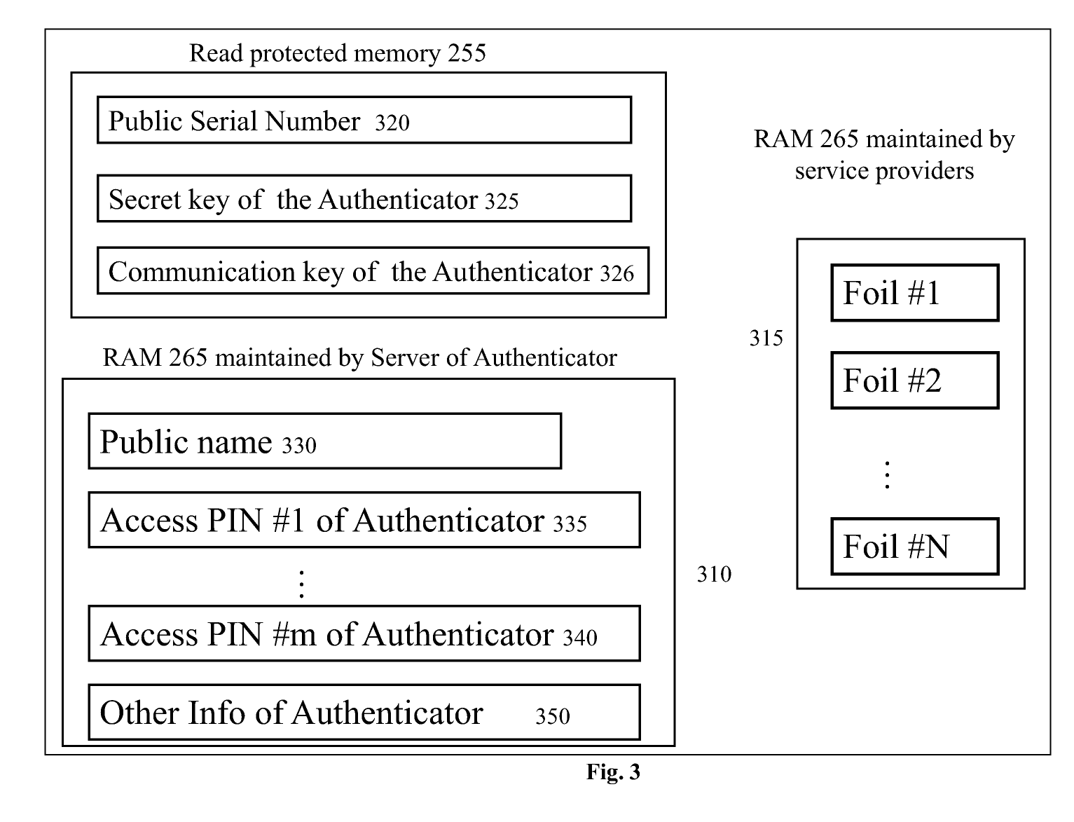

FIG. 3 illustrates the read protected memory 255 and the RAM 265 in the memory system of the computing module 205 in FIG. 2. As described above, the memory system may comprise a read/write-protected memory 255, a ROM 260 and a RAM 265. Referring to FIG. 3, a public serial number 320, a secret key 325 of the authenticator and a communication key 326 are stored in the read protected memory 255 of the authenticator and are protected from outside intrusion. The public serial number 320, the secret key 325 and the communication key 326 are confidential information on the authenticator and is stored in the read protected memory 255 which cannot be read by external devices under normal condition even if snapped out of the authenticator.

The keys and numbers stored in the read protected memory 255 can be set by the manufacturer of the authenticator during the manufacturing process of the authenticator. A server of the authenticator uses these keys and numbers to identify and provide services to the authenticator, i.e. initiation service and maintenance service. The server of the authenticator can be one provided by the manufacturer or an independent entity. To enable the communication between the authenticator and the server of the authenticator in one embodiment, before any service is rendered to the authenticator, the server of the authenticator obtains information on the keys and numbers regarding the authenticator from the manufacturer. The process of service will be described in more detail below.

The secret key 325 is used to generate one or more One Time Authentication Codes (OTACs) for authenticating with a server of the authenticator. The authenticator uses the communication key 326 to encrypt and decrypt data in communicating with the server of the authenticator using either a symmetric cryptology scheme or an asymmetric cryptology scheme determined by the server of the authenticator. When a symmetric cryptology scheme is chosen, the authenticator and the server of the authenticator use the same key to encrypt and decrypt messages communicated with each other. When an asymmetric cryptology scheme is chosen, the communication key is a private key of a public key and private key pair, where the pair is determined by the manufacturer. The authenticator uses the private key to encrypt and decrypt messages communicated with the server of the authenticator. The server of the authenticator uses the public key to encrypt and decrypt messages from the authenticator. The symmetric and asymmetric cryptology schemes are well known in the art and detailed descriptions thereof are omitted for conciseness.

Memory 310 stores dynamic data maintained by the server of the authenticator. For example, the server of the authenticator instructs the authenticator to write to, change, and/or update the data in memory 310. In one embodiment, an entity that maintains the memory 310 (herein also referred to as “maintaining entity”), for example, the server of the authenticator, controls writing to and updating of the data in memory 310. In this embodiment, any entity other than the maintaining entity, including the user of the authenticator, cannot directly write to the memory 310. A user or another entity that wishes to change the memory 310 sends a request to the maintaining entity. For instance, the memory can be set by the user or another entity by requesting and receiving a code from the maintaining entity. This code may contain encrypted commands and data executable in the computing module 205 internally to set the memory.

The server of authenticator maintained memory 310 may include a public name 330 of the authenticator, several access personal identification numbers (PINS) 335-340, and other information are stored therein. The server of the authenticator sets the aforementioned information during the initiation and maintenance processes through commands and data sent to the authenticator. The initiation and maintenance processes will be described in more detail below.

Memory 315 stores a plurality of foils 1-N. Each of the foil in a working condition is set up to be exclusively associated with a service provider. The service providers are the entities that the authenticator provides OTAC to authenticate with. The service providers can be a credit card company, a bank, an online account etc. Each of the foil is maintained by its corresponding service provider. Each foil provides information necessary to generate the OTAC for the service provider with which the foil associates. The authenticator can simultaneously provide as many OTACs as the number of foils. When a particular service provider is specified by the user, the authenticator will calculate the OTAC based on the information stored on the foil associated with the service provider. The generation of the OTACs will be described in more detail below.

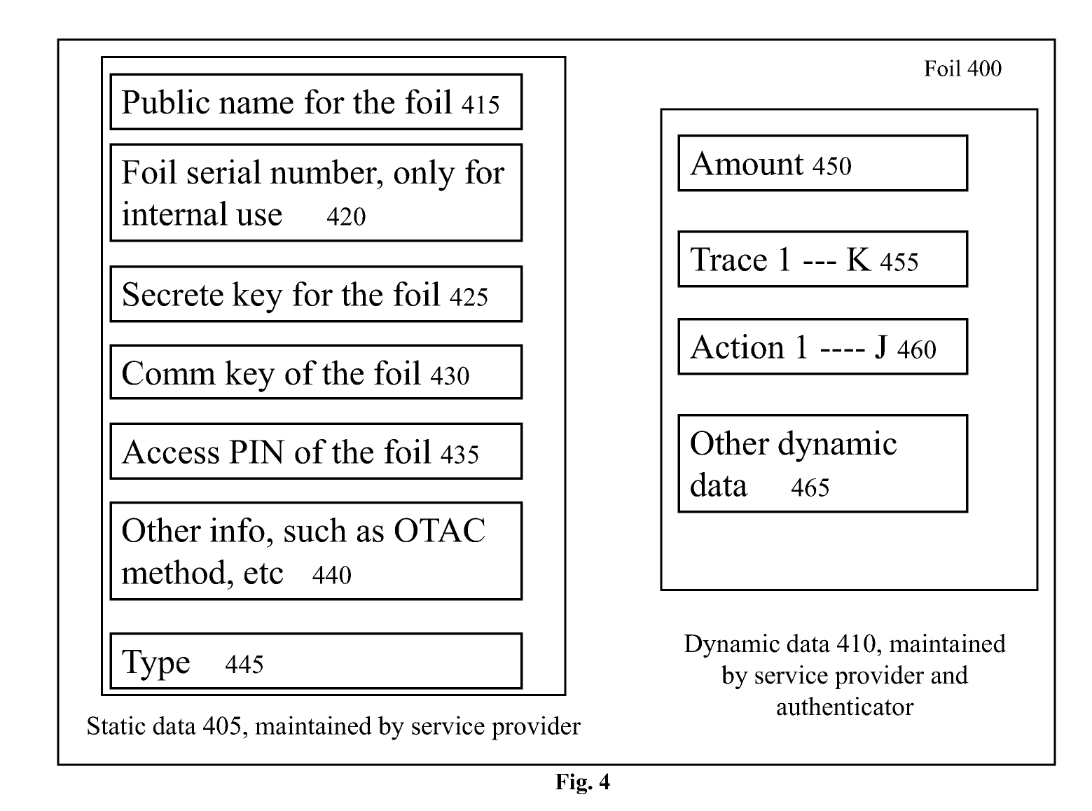

FIG. 4 is a block diagram illustrating the logical design of one of the foils 1-N 315 in FIG. 3 according to an embodiment of the present disclosure. Referring to FIG. 4, foil 400 includes static data 405 maintained by the service provider and dynamic data 410 maintained by the service provider and the authenticator. The static data 405 is exclusively maintained by the service provider associated with the foil. The static data 405 includes a public name for the foil 415, a foil serial number 420 for internal use, a secret key 425 of the foil, a communication key 430 of the foil, an access PIN 435, other information 440 and a type 445. The service provider sets static data during the association process through commands and data sent to the authenticator. The association process will be described in more detail below. The static data may be maintained/changed by service provider occasionally comparing to dynamic data that may change dynamically and frequently.

The dynamic data 410 maintained by the service provider and the authenticator includes an amount variable 450, such as a balance on a credit card when the service provider is a credit card company, a trace variable 455 which is a one-time variable that changes its value, an action variable 460 storing past actions taken with regard to the service provider, and other dynamic data 465 storing further information on the service provider. The dynamic data 410 is maintained both by the service provider and the authenticator. That is, both the service provider and the authenticator may write to the memory storing dynamic data 410. Meanwhile, the service provider maintains a copy of the dynamic data 410. When there is a change to the dynamic data 410 in either the authenticator or the service provider, the other copy will be updated accordingly when the authenticator is being maintained.

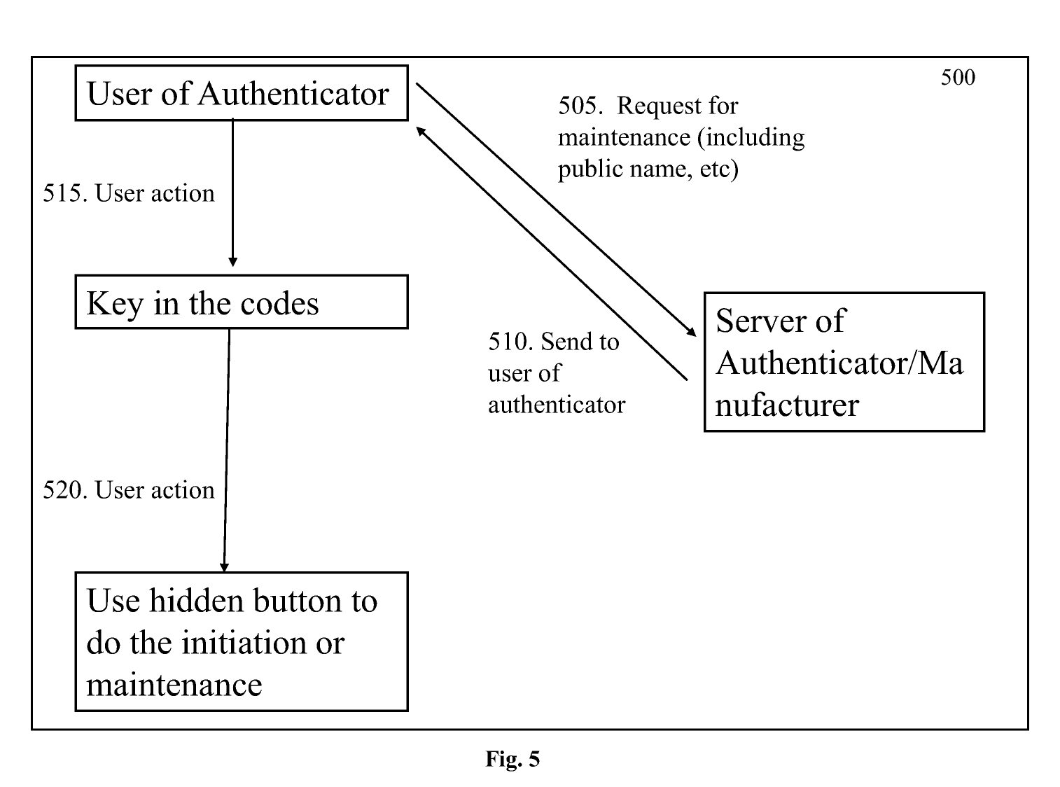

FIG. 5 is a flowchart of a process illustrating the process of maintenance of the handheld electronic authenticator according to an embodiment of the disclosure. As described above in FIG. 3, the memory 310 is maintained by the server of the authenticator. When a user intends to update the items stored in memory 310, such as the public name 330 of the authenticator, a request must be sent to the server of the authenticator. Referring to FIG. 5, in step 505, the user of the authenticator sends a request to the server of authenticator. If the authenticator is authenticated by the server of the authenticator using a process similar to what is used to authenticate authenticator with a service provider, the server of authenticator will provide maintenance service to the authenticator. The process of authenticating with the service provider will be explained in more detail below. In step 510, the server of the authenticator sends a code back to the authenticator providing relevant data requested by the authenticator. The code is encrypted using a cryptology scheme as describe above. In step 515, the user enters the encrypted code into the authenticator through a communication means, e.g. the keypad, or other means. In step 520, the user presses a key, e.g. a hidden key to initiate the internal maintenance of the authenticator. Receiving the signal from the hidden key, the authenticator decrypts the encrypted code and sets the data contained therein on the memory 310.

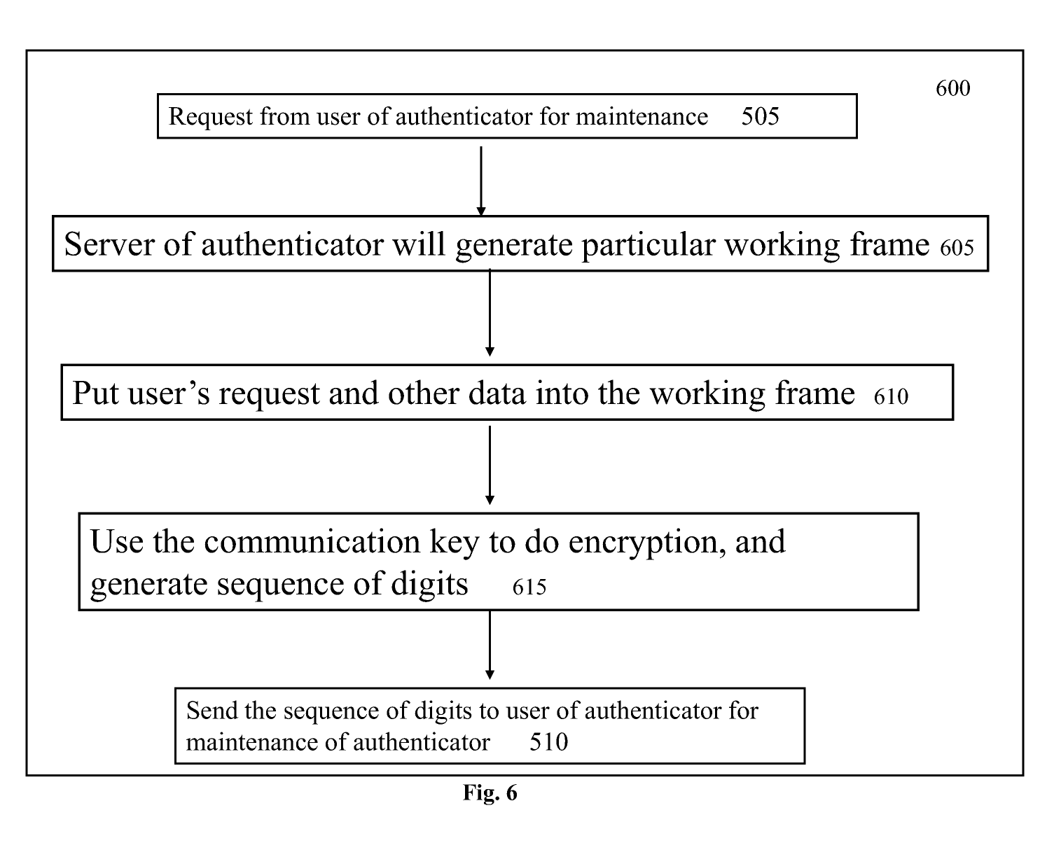

FIG. 6 illustrates the process implemented inside the server of the authenticator from when the request for maintenance is received in step 505 till the code is sent out in step 510 in FIG. 5. Referring to FIG. 5, after receiving the request for maintenance from the authenticator, the authenticator will first authenticate whether this authenticator is an authorized device by checking the OTAC generated based on the secret key 325 of the authenticator. The authentication process herein is similar to what is used in the service provider, which will be described in more detail later. Thereafter, in step 605, the server of the authenticator will generate a working frame instruction. The working frame instruction contains maintenance data and command corresponding to the user's request for maintenance. In step 610, the server aggregate the maintenance data according to the working frame instruction. In step 615, the server encrypts the frame using an encryption key associated with the authenticator according to the predetermined cryptology scheme and generates the code to be sent to the authenticator. Thereafter, step 510 will be executed according to the process described above in connection with FIG. 5.

An initiation process executed before the first use of the authenticator is similar to the maintenance process described above in connection with FIGS. 5-6. When the authenticator completes the initiation process, it is ready to be set up with service providers to provide the OTACs.

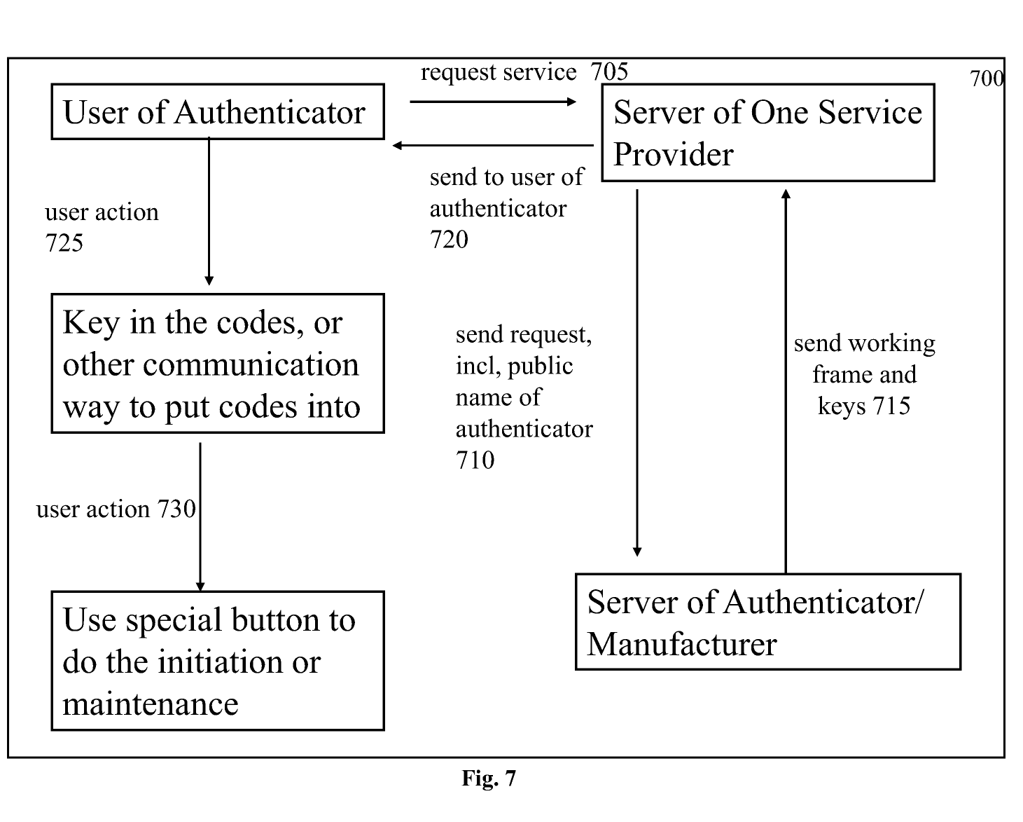

FIG. 7 is a flowchart of a process of maintenance of a foil of the authenticator according to an embodiment of the present disclosure. Referring to FIG. 7, in step 705, the authenticator sends a request to the service provider associated with the foil for maintenance. In step 710, the service provider sends a request to the server of the authenticator regarding the initiation and maintenance request from the authenticator. The request contains a name and other information of the authenticator to indicate the particular authenticator to the server of the authenticator. In response, the server of the authenticator sends a working frame instruction and keys of the authenticator back to the service provider in step 715. The working frame instruction contains data maintained by the server of the authenticator corresponding to the user's request for maintenance. The keys are 1) communication keys for encryption and decryption of the codes sent between the service provider and the authenticator, and 2) part of secret keys that will be combined with other parts to form secret key and secret communication key. The service provider processes the received information from the server of the authenticator and sends a code back to the authenticator in step 720. In step 725, the user enters the code through a communication means, e.g. the keypad. In step 730, the user presses a hidden key to initiate the internal maintenance of the foil. Receiving the signal from the hidden key, the authenticator decrypts the encrypted code, and combines the data obtained from the code with secret keys in the authenticator to form secret key and secret communication key of the foil, and sets the data contained therein on the foil.

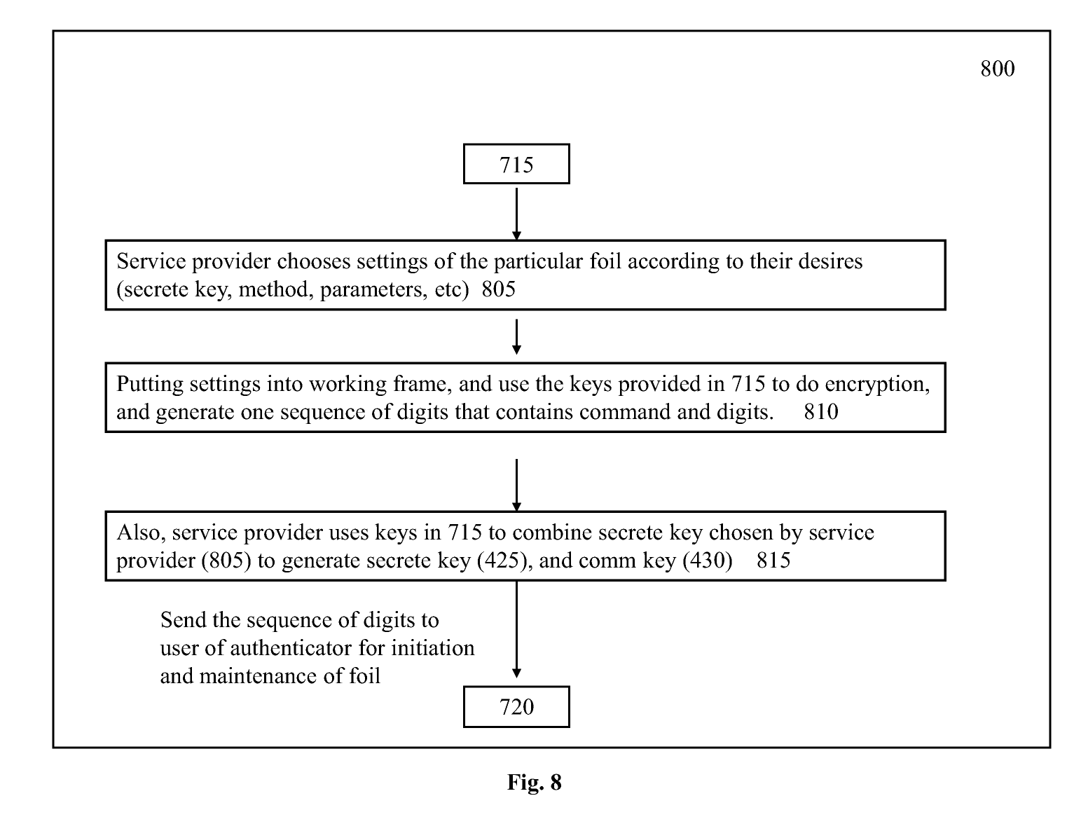

FIG. 8 illustrates the process executed inside the service provider after receiving the working frame file in step 715 for sending the code out in step 720 in FIG. 7. Referring to FIG. 8, after receiving the working frame file from the authenticator, the service provider chooses the settings for the particular foil in step 805. In step 810, the service provider puts data maintained by the service provider corresponding to the server's request into the received working frame file. In step 815, the server encrypts the frame file using the key received in step 715. According to the cryptology scheme chosen by the service provider, the server uses the key received in 715 to encrypt the frame file into a code comprising a sequence of digits. The cryptology scheme could either be a symmetric cryptology scheme or an asymmetric cryptology scheme. The code generated using the asymmetric scheme is longer than using the symmetric scheme but it also is more secure. The service provider can choose either scheme or others that best fits its purpose.

An initiation process to set up the association between the service provider and the authenticator is similar to the maintenance process described above in connection with FIGS. 7-8. When the authenticator completes the initiation process, it is ready to be set up with service providers to provide the OTACs.

Each foil is initiated and maintained using the same process described above in connection with FIGS. 7-8. After initiation or maintenance, the authenticator will be able to generate OTACs using the information set on the foils of the authenticator for authentication. The process of authentication with the service providers will be described in more detail below.

One advantage offered by the present disclosure is that the server of the service provider sets up the secret key 425 and the communication key 430 of the particular foil. The secret key 425 and the communication key 430 are information that is strictly kept confidential in order to make the OTACs unpredictable, thus preventing others such as hackers from simulating the codes. In current OTAC-based authentication systems, the manufacturer sets up and knows the keys in the authenticator. In the present disclosure, due to the design that the service provider sets up the keys, and in the foils, the manufacturer does not know the keys thus cannot predict the codes used between the authenticator and the service provider. This design is more secure than the current OTAC-based authentication systems because it eliminates the manufacturer from the system, which could be a potential source for compromising the keys.

After the initiation or maintenance, the particular foil is successfully associated with the service provider and is ready to provide the OTACs for authentication. The authenticator can be used in authentication.

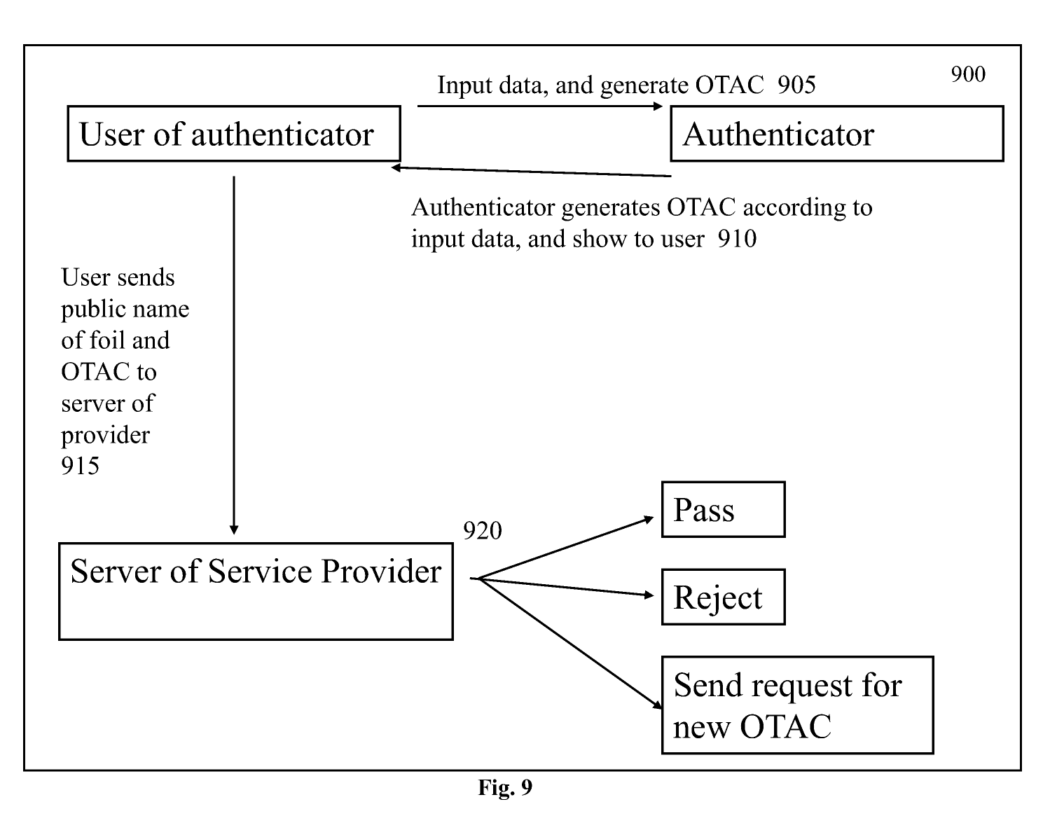

FIG. 9 is a flowchart illustrating the process of authentication according to an embodiment of the present disclosure. Referring to FIG. 9, in step 905, the user inputs data to indicate to the authenticator to request for an OTAC with respect to a service provider. In step 910, the authenticator generates the OTAC based on the information stored on the foil associated with the service provider. In step 915, the user provides the public name of the foil 415 associated with the service provider and the OTAC to the service provider for authentication. Step 915 may be accomplished by entering the OTAC into a website of the service provider through an authentication page or interface. In step 920, the service provider determines whether to grant authentication, deny authentication or send a request back to the authenticator for a new OTAC.

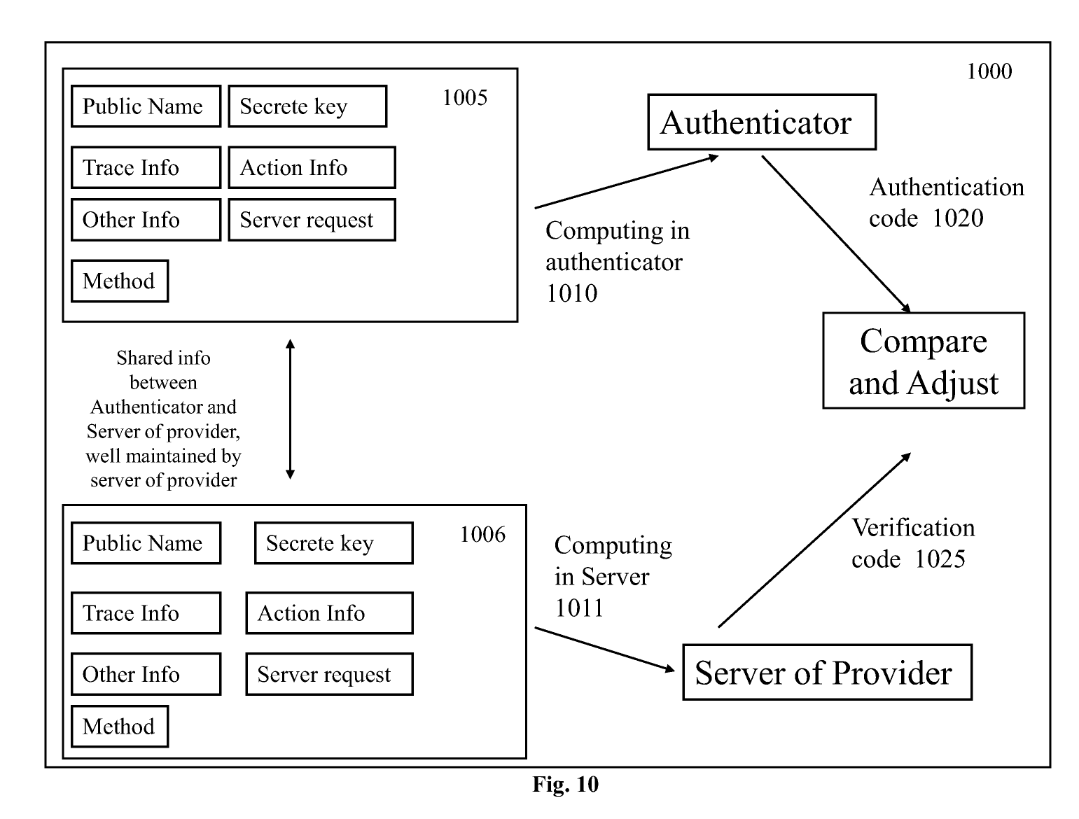

FIGS. 10-12 describe in detail the authentication process described in FIG. 9. An OTAC is generated as a function of multiple inputs to a predetermined algorithm. Referring to FIG. 10, as shown in 1005 and 1006, the inputs for generating the OTAC may include: the public name of the foil, the secret key, trace information related to a dynamic variable, action information regarding past actions taken on the foil, other information, server request, and a method. The inputs are both stored in the authenticator as illustrated in 1005 and in the server of the service provider as illustrated in 1006. Under an ideal working condition, the two sets of inputs 1005 and 1006 are identical. In steps 1010 and 1011, the authenticator and the service provider both generate OTACs based on inputs 1005 and 1006. The OTAC from the authenticator is an authentication code generated by the authenticator using one or more combinations of information shown in 1005 pending authentication. The OTAC from the service provide is a verification code independently generated by the service provider using one or more combinations of information shown in 1006, which is used to authenticate the authentication code. In steps 1020 and 1025, the authentication code and the verification code are compared to each other. For instance, the service provider compares the verification code with the authentication code received from the authenticator.

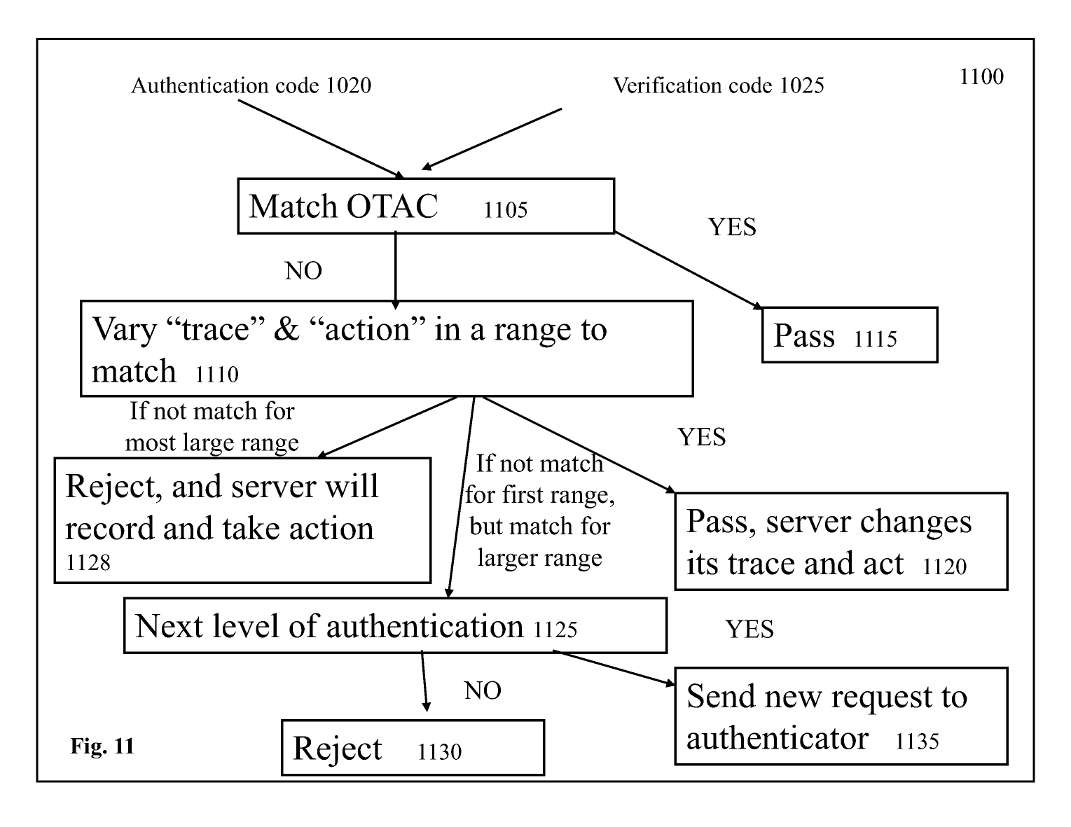

FIG. 11 is a continued flowchart from FIG. 10 further describing the comparison steps of the authentication code and the verification code. Referring to FIG. 11, in step 1105, the authentication code and the verification codes are compared to each other. For example, the server compares the authentication code sent from the authenticator and received at the server of the service provider. If the two codes match, the server may authenticate the authentication code and grant the requested access to the user of the authenticator in step 1115. If the two codes do not match, the server will vary the trace input and the action input in a predetermined range and generate new verification codes in order to adjust for permissible inconsistencies between the trace inputs and the action inputs in the authenticator and the service provider. This step is taken because as described above, the trace input and action inputs are dynamic data both maintained by the authenticator and the service provider. In an ideal condition, the trace and action are identical in the authenticator and service provider. However, under normal working condition, many times the synchronization of the dynamic data are not timely updated or adjusted. Therefore, there may be small discrepancies. These discrepancies are permissible and accounted for in the present disclosure in one embodiment.

In step 1110, the newly generated verification codes within the predetermined range are further compared with the authentication code. If there is a match, the server will authenticate the authenticator in step 1120. If the authentication code is largely off range comparing to the verification code, the server will reject the request in step 1128. An authentication code may be determined as being largely off if it is outside threshold. The threshold is predetermined by the service provider depending on its security policy. If the authentication code is neither largely off range nor correct, the server will conduct a next level of authentication in step 1125. After the next level of authentication, the service provider will decide whether to finally reject the request for authentication in step 1130 or send a request for new authentication code in 1135.

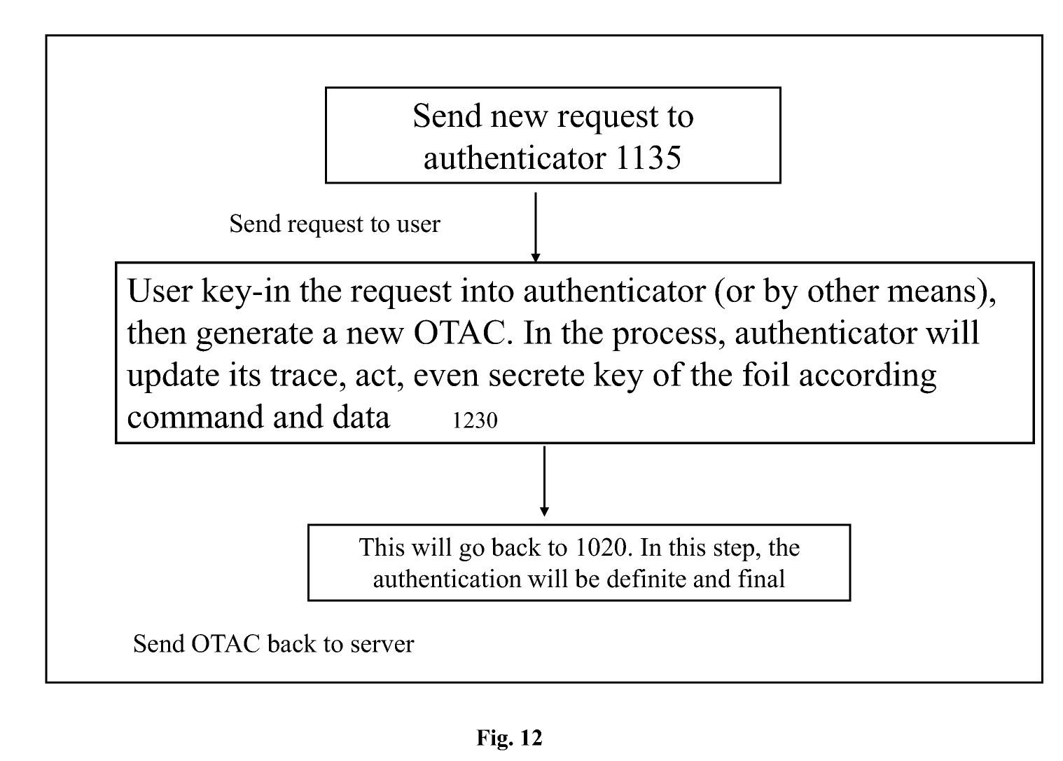

FIG. 12 is a continued flowchart from FIG. 11 further describing step 1135 of requesting a new authentication code. As described above, when the authentication code does not match the verification code but is not largely off, the service provider will send a request for a new authentication code. Referring to FIG. 12, when the authenticator receives a code comprising a request from the service provider, the user keys in or through other means inputs the code to the authenticator in step 1330. During this process, the authenticator generates a new authentication code with the new server request, trace and action inputs. Then, the authenticator resends the new OTAC to the service provider. In response to receiving the new authentication code, the new authentication code will be compared to a new verification code based on the new server request, trace and action inputs using the same steps as illustrated in FIG. 11.

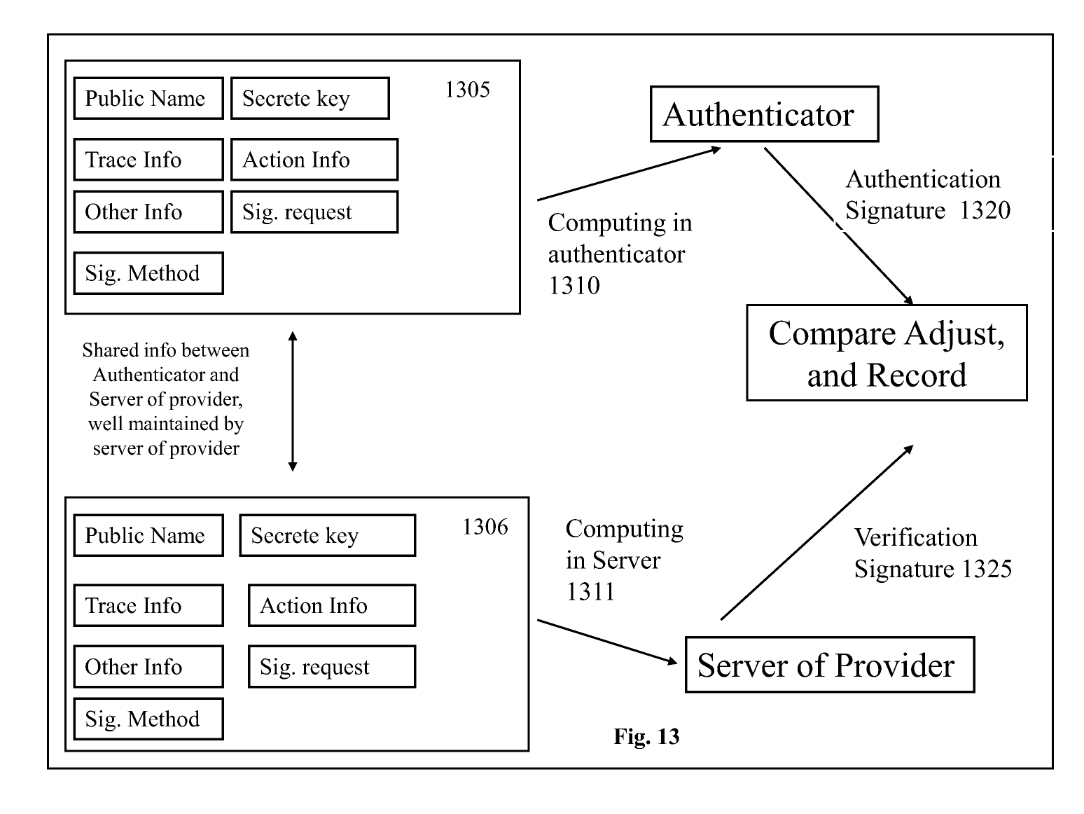

The authenticator may also be used to generate electronic signatures. The process in determining the authenticity of the signature is similar to what is described above in connection with FIGS. 10-12. FIG. 13 is flowchart of a process of signature generation according to the present disclosure. The inputs for generating the signature may include: the public name of the foil, the secret key, trace information related to a dynamic variable, action information regarding past actions taken on the foil, other information, signature request, and a signature method. Any combinations of several of the information may be used to generate the signature. The inputs are both stored in the authenticator as illustrated in 1305 and in the server of the service provider as illustrated in 1306. Under an ideal condition, the two sets of inputs 1305 and 1306 are identical. In steps 1310 and 1311, the authenticator and the service provider both generate signature OTACs based on inputs 1305 and 1306. The signature OTAC from the authenticator is a signature authentication code pending authentication. The signature OTAC from the service provider is a signature verification code used to authenticate the authentication code. In steps 1320 and 1325, the signature authentication code and the signature verification code are gathered together and compared to each other. For instance, the server compares the signatures. The process taken thereafter to authenticate the signature authentication code is identical to what is described in FIGS. 11-12. When the signature authentication code is authenticated, the signature is recorded and the underlying transaction is endorsed.

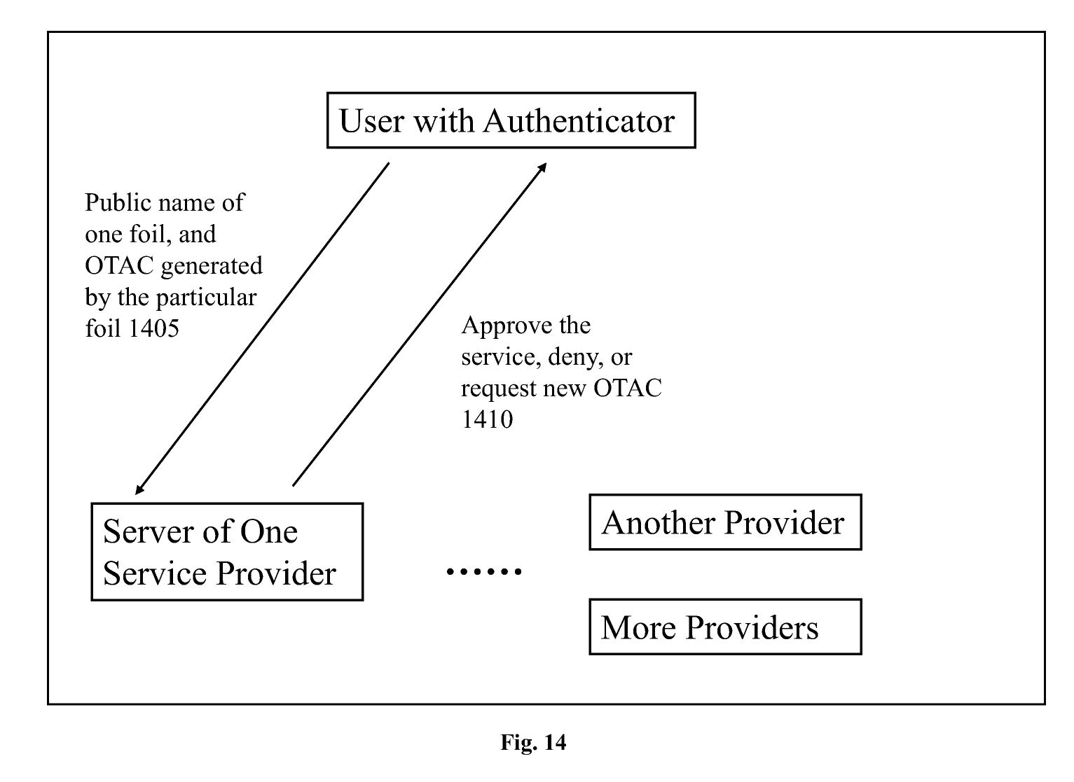

FIGS. 14-16 are flowcharts of processes using the handheld electronic authenticator in conducting transactions.

FIG. 14 is a flowchart of a process using the handheld electronic authenticator to request service from a service provider. Referring to FIG. 14, a user with authenticator using a public name on one foil and the OTAC generated therein to gain access to the service provider in step 1405. In step 1410, the service provider approves, denies or requests new OTAC, using the process described above in connection with FIGS. 10-13. Similarly, the user can gain access to all service providers, each associated with one of the foils of the authenticator. Using the OTACs in combination with the public name of the foil (associated with that service provider), the user can conduct business transactions with the service providers, but the confidential information is never disclosed during the process.

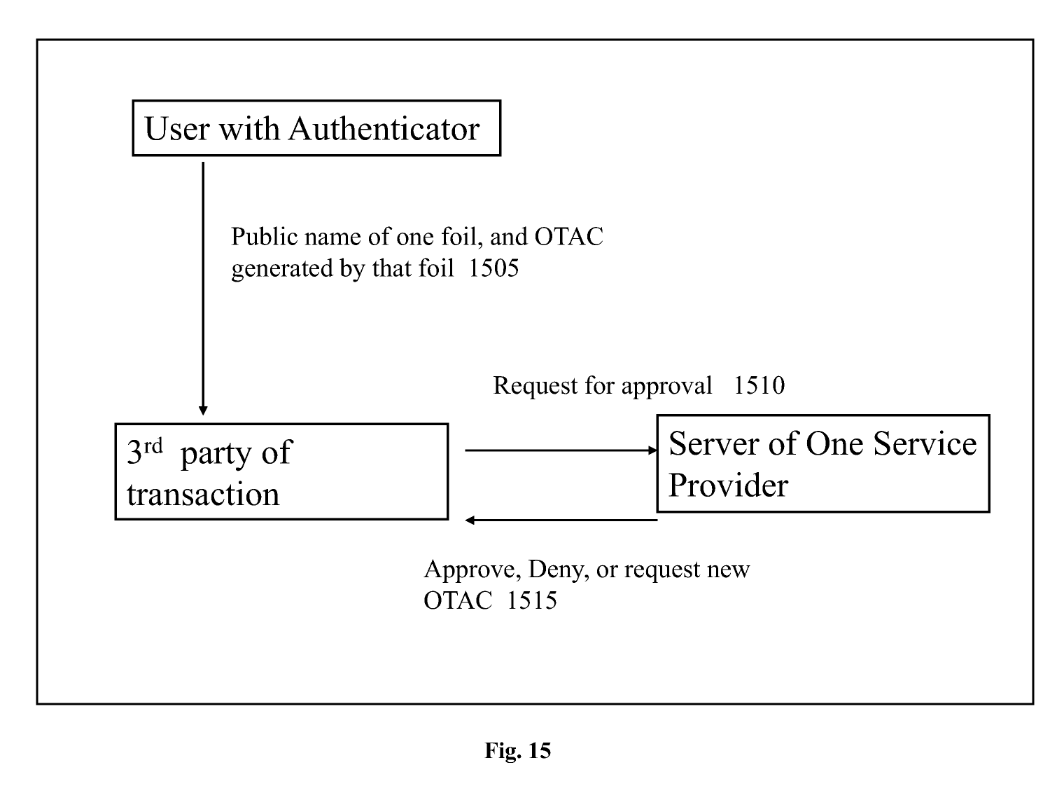

FIG. 15 is a flowchart of a process using the handheld electronic authenticator in a transaction with a 3rd party. The 3rd party is a party that the user of the authenticator deals with in transaction, for example a vendor. The 3rd party requires information from the user of the authenticator to conduct the transaction, for example a credit card number. Instead of giving the credit card number to the vendor, the user of the authenticator can give the public name of the foil and the OTAC to the 3rd party. This process is illustrated in FIG. 15. Referring to FIG. 15, the user of the authenticator provides the public name of the foil (associated with that service provider) and the OTAC thereof to a counter party of a transaction that requires confidential information, such as a bank account. In step 1505, the user provides the public name and OTAC to the counter party. The counter party requests access to the service provider using the public name and OTAC in step 1510. In step 1515, the server of the service provider will approve, deny or request new OTAC as describe above in connection with FIGS. 10-12. Since the OTAC is a dynamic variable, for example time-based, the counter party cannot gain access to the service provider after the time period in which the OTAC is valid has lapsed.

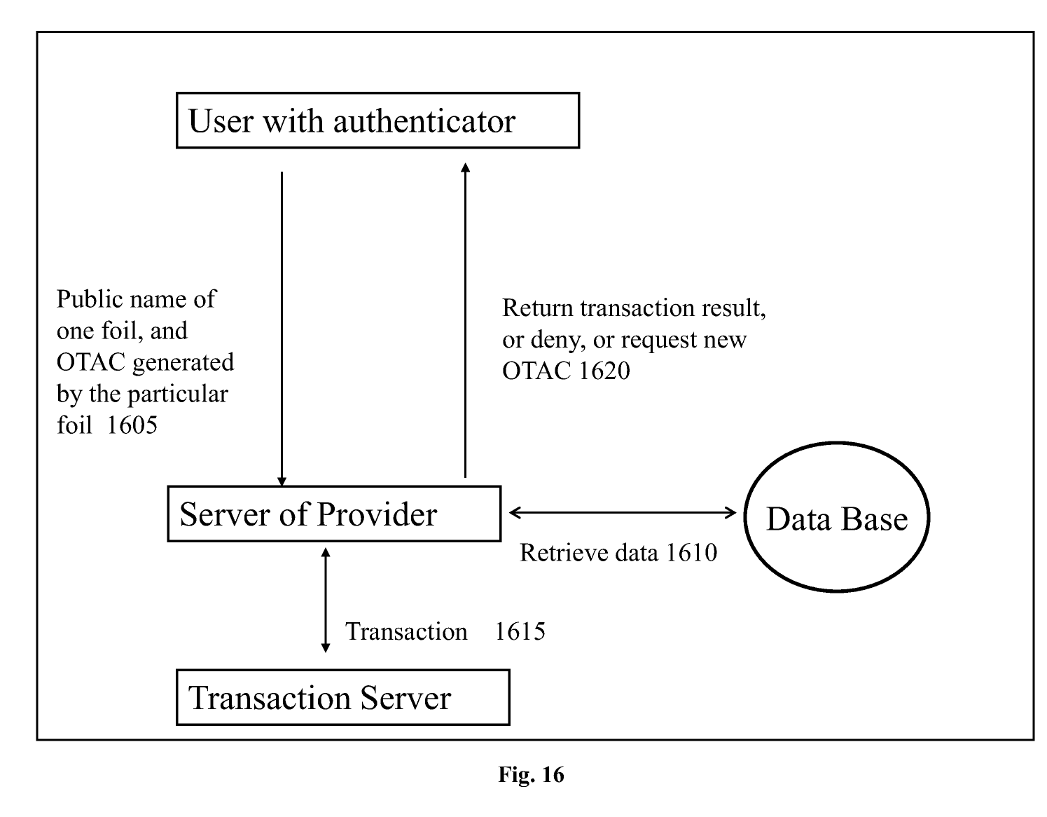

FIG. 16 is a flowchart of a process using the handheld electronic authenticator in a transaction with more data required by the service provider. Referring to FIG. 16, the user of the authenticator sends the public name and the OTAC of one foil to the server of service provider in step 1605. The server of the service provider retrieves more data from a database in step 1610. In step 1615, the server of service provider sends a traction request to a transaction server. In step 1620, the transaction result is either returned to the user if the authenticator was authorized or a request for a new OTAC or denial of access is returned.

As illustrated in FIGS. 14-16, during the transactions only a public name of a foil and the OTAC generated by the foil are used to gain access to the service provider. The confidential information, such as a credit card number or a social security code, is not disclosed. The public name of the foil (associate with that service provider) and the OTAC are used as a proxy for the confidential information when authentication is required for the transaction. This method provides convenience to the user for relieving the need of a user to memorize all his/her confidential information. It also provides better security in that the confidential information is not disclosed either to a third party or to a communication channel for gaining access to service providers.

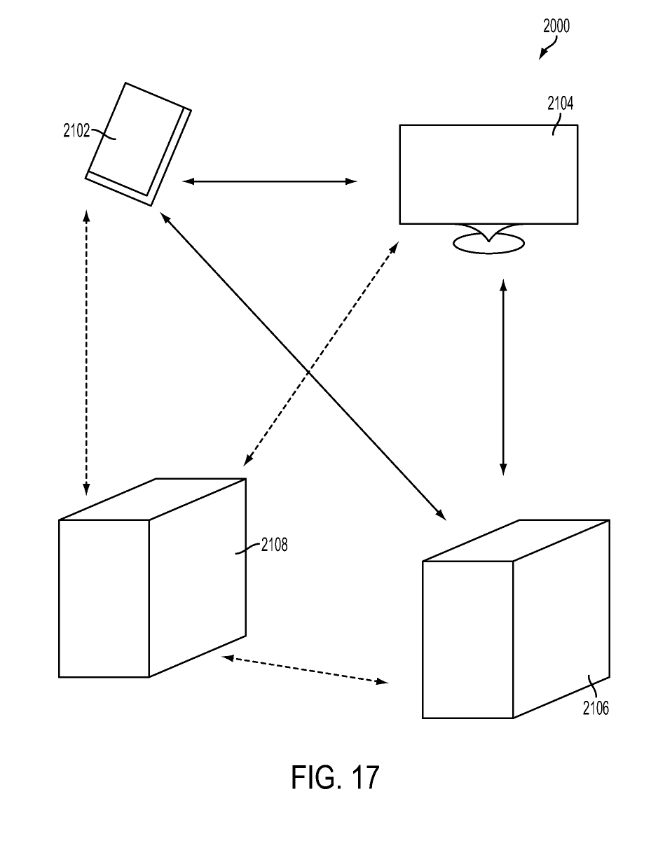

FIG. 17 is a block diagram showing a multi-factor and multi-channel ID authentication and transaction control system 2000 according to an embodiment of the disclosure. The system 2000 includes a handheld electronic device 2102, a terminal 2104 in communication with the handheld electronic device 2102, and a server 2106 of a service provider. The service provider is capable of communicating with both the handheld electronic device 2102 and the terminal 2104 through the server 2106. The system 2000 further includes a server 2108 of the handheld electronic device 2102, which can communicate with the handheld electronic device 2102, the server 2106 of the service provider and the terminal 2104.

The handheld electronic device 2102 includes but is not limited to hardware and/or software components embodied in hardware, such as a cell phone or smart phone with specialized software. The handheld electronic device 2102 has a plurality of foils, each of which is associated with one or more service providers. The handheld electronic device 2102 also has a component associated with the server 2108 of the device. For example, the handheld electronic device 2102 can further provide functionalities of scanning, networking, showing barcode, performing Near Field Communication (NFC) and so on.

The terminal 2104 includes but is not limited to hardware and/or software components embodied in hardware. For example, the terminal 2104 can be a computer with a web browser or likely user interface, a Point Of Sale (POS) machine, and so on. The server 2106 of the service provider includes but is not limited to a computer, a processor and the like, which is capable of maintaining database and implementing a predetermined algorithm. The terminal 2104 and the server 2106 of the service provider can be integrated into a same computer. The server 2108 of the device is similar to the server 2106 of the service provider. The server 2108 of the device in one embodiment acts in predetermined situations, such as during personalization and binding processes of the ID authentication and transaction control, which will be described later. In one embodiment, the server 2108 does not participate in any processes during the ID authentication and transaction control. In one embodiment, the server 2108 and the server 2106 each provides at least one communication channel of a high secure level. Thus, even in case that other communication channels of the servers are not of a high secure level, the security concern can still be properly addressed, because the server 2106 and the server 2108 guard the ID authentication and transaction control.

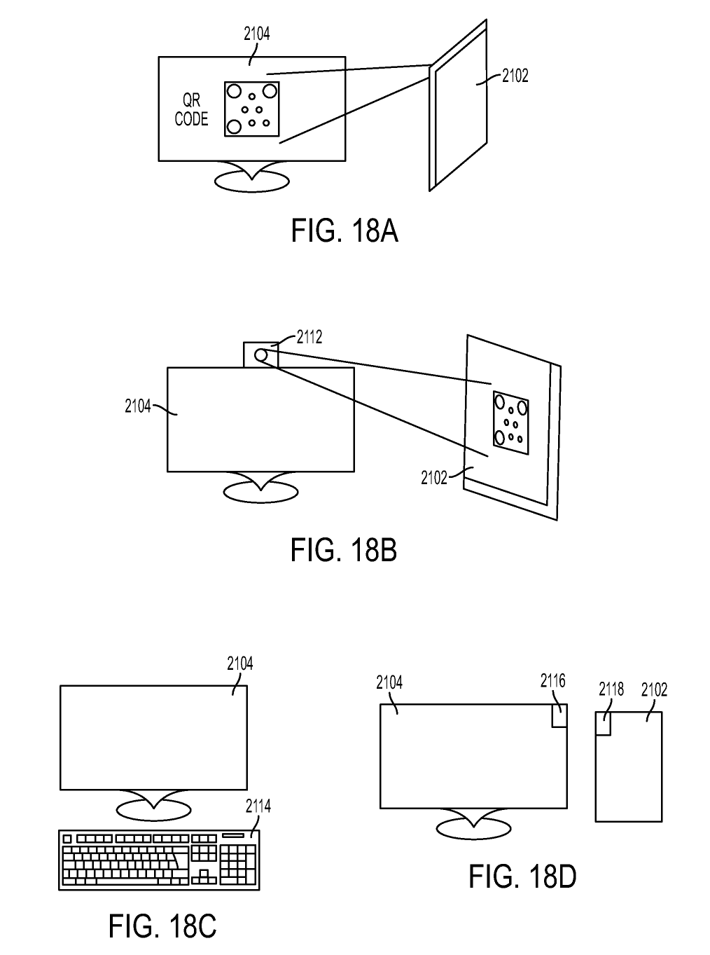

FIGS. 18A-18D are schematic diagrams illustrating the communication between the handheld electronic device 2102 and the terminal 2104.

FIG. 18A illustrates a scan-in communication, in which information, such as a Quick Response (QR) code, is scanned from the terminal 2104 into the handheld electronic device 2102. FIG. 18B illustrates a scan-back communication, in which information, such as a QR code, is scanned back from the handheld electronic device 2102 to a camera 2112 of the terminal 2104. These two types of communication can be combined to provide a scan-scan communication. For example, a user scans the barcode on a terminal screen with the handheld electronic device 2102 and the handheld electronic device 2102 subsequently generates a corresponding barcode and displays the barcode on its own screen; the user then directs the screen of the device 2102 to the terminal's camera 2112 and the terminal 2104 reads and decodes the barcode generated by the device 2102.

FIG. 18C illustrates a type-in communication, in which the user types information from the device 2102 into the terminal 2104 or from the terminal 2104 into the device 2102, through a keyboard 2114. The type-in communication can be combined with the scan-in communication. For example, the user can scan a barcode on the terminal screen and then type information shown on the device screen, responsive to the barcode, into the terminal.

FIG. 18D illustrates a read/write communication, in which the device 2102 can read information from an NFC tag 2116 of the terminal 2104 and write information from the terminal 2104 into its own NFC tag 2118. Similarly, the terminal 2104 can read information from the NFC tag 2118 of the device 2102 and write information from the device 2102 into its own NFC tag 2116. The NFC communication is a form of communication, which would only be activated within a very short distance (so-called Near Field). Such communication can be implemented by various technologies, such as radio, sound, infrared, magnetic, optical (for example, QR scan). All these varieties are within the scope of this disclosure.

The above-described communication between the device 2102 and the terminal 2104 can be one-way, such as scan-in, or two-way, such as scan in and scan back. These types of communication render the entire system 2000 user-friendly and truthfully reflect users' intentions, such that a communication can only be implemented when the communication is intended by the users. However, a person of ordinary skill in the art understands that the communication between the device 2102 and the terminal 2104 is not limited to the above-described types and forms.

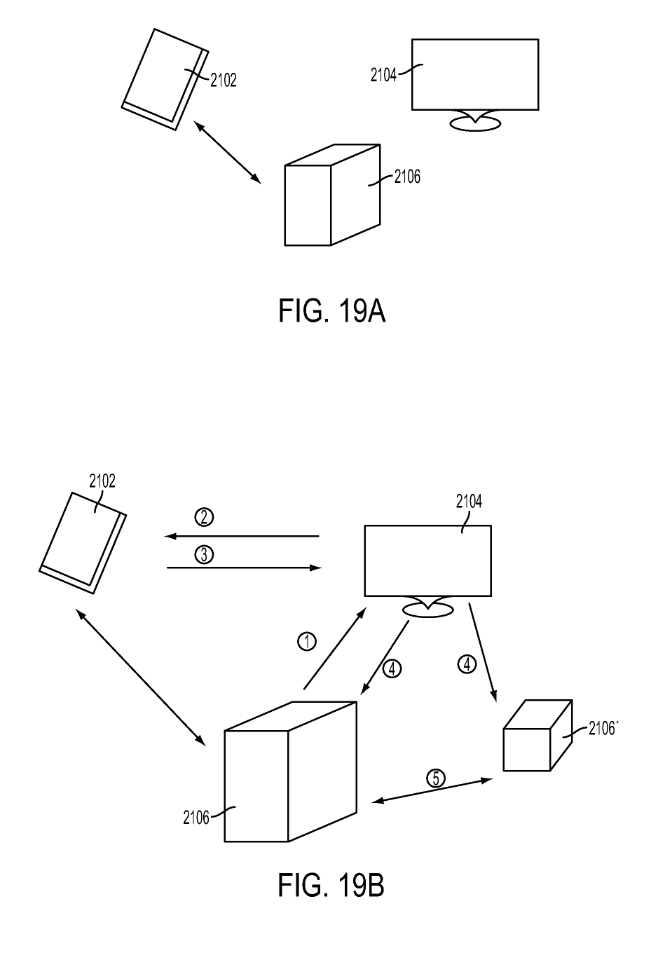

FIGS. 19A-19B are schematic diagrams illustrating the communication between the handheld electronic device 2102 and the server 2106 of the service provider.

The device 2102 can directly communicate with the server 2106, as shown in FIG. 19A. This direct communication can be implemented through the network capacity of the device 2102, such as 2G, 3G or WIFI communication or the like. The direct communication is a two-way communication.

The device 2102 can indirectly communicate with the server 2106 through the terminal 2104 as a middle station, as shown in FIG. 19B. In the indirect communication, the server 2106 sends an instruction message to the terminal 2104, which includes messages to be prepared at the terminal 2104, encryption methods of messages, destination of messages, and the like. The terminal 2104 sends the processed messages to the device 2102. Upon receiving messages from the terminal 2104, the device 2102 generates a response message and sends it back to the terminal 2104. Upon receiving the response message, the terminal 2104 sends it to the server 2106, or another server 2106′ which is specified by the server 2106 and is typically another server of the same service provider. The different servers can communicate among themselves and the communication can be considered internal communication, which is of satisfactory secure level. For example, the terminal 2104 does not decrypt messages, but instead sends messages according to instructions. The device 2102 and the server 2106 share symmetric keys, which allows the device 2102 and the server 2106 to establish a highly secure communication channel and communicate with each other properly. Thus, even though the communication goes through the terminal 2104, the communication is of multi-channel, which can effectively detect attacks like MITM attacks.

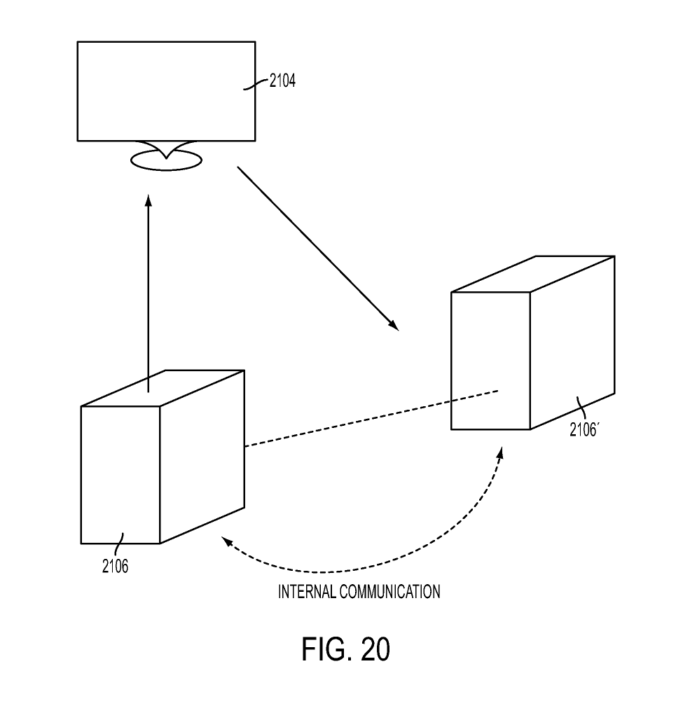

FIG. 20 is a schematic diagram illustrating the communication between the terminal 2104 and servers of service providers (such as the server 2106 and the server 2106′). The communication between the terminal and the servers can be synchronized, such as TCP/IP socket. Alternatively, the communication can be asynchronous, such as JAXA interactions. For example, the terminal 2104 can have Internet communication channels for the servers. With Internet, a server can instruct the terminal 2104 to send information to the destination determined by the server. Since the system 2000 integrates several levels of one-time code, any violation of instructions, such as violations caused by attacks, will be recognized on the server side.

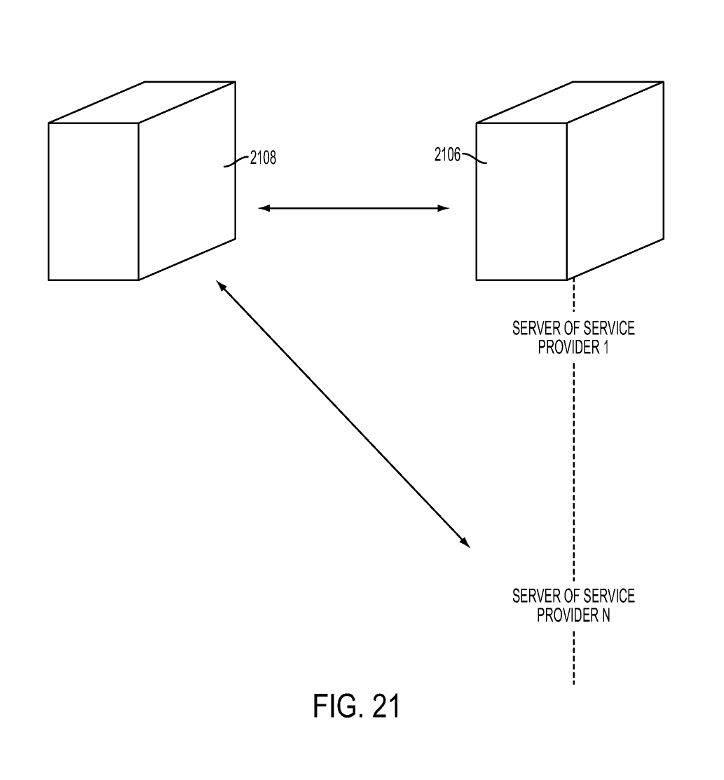

FIG. 21 is a schematic diagram illustrating the communication between the server 2108 of the device 2102 and servers of service providers (such as the servers 2106 and 2106′). The communication between the server 2108 of the device 2102 and the servers 2106, 2106′ of the service providers is only used, when the device 2102 is associated with (through a binding process) or disassociated from (through an unbinding process) the service provider. The device server 2108 communicates with all servers of the service provider in a communication channel of a high secure level. The servers' communication can be of a high secure level and the communication during a binding/unbinding process can be accomplished in a public communication channel. Thus, even assuming that an attacker invades the communication channel, the server of the device and the server of the service provider would guard the communication. To ensure a higher-level security, the communication channel between the servers can be set to a higher secure level.

According to an exemplary aspect of the present disclosure, a method of multi-factor and multi-channel ID authenticating and transaction controlling is provided. The method will now be described with reference to the system 2000 shown in FIG. 17.

The method includes personalizing the handheld electronic device 2102 to allow the device to share at least one symmetric key with the server 2108 of the device. The personalization of the device 2102 can be implemented on site when the device 2102 is manufactured or by installing pre-personalized hardware into the device 2102.

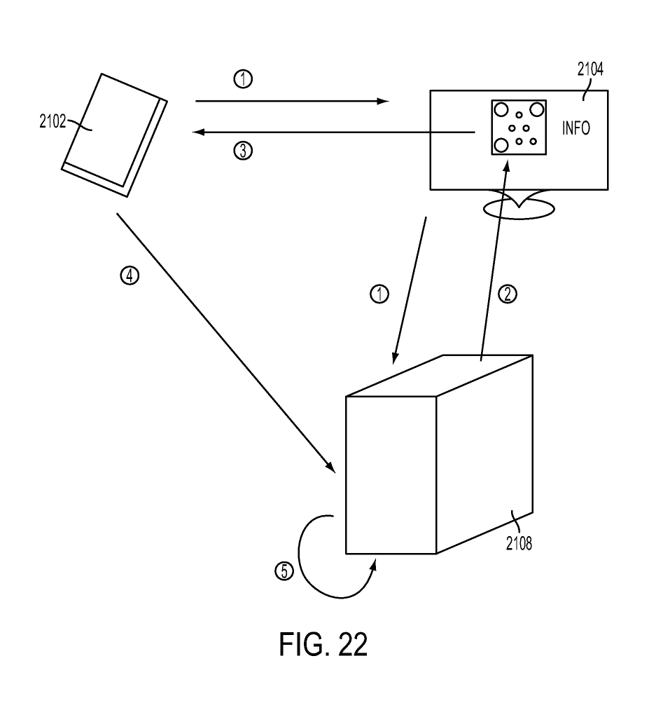

Alternatively, the personalization can be implemented through the process shown in FIG. 22. After a user installs a software component on her/his device (such as a smart phone), the software component is not yet personalized. Thus, there is no data unique to this device. The following process can establish unique data to the device and thus to personalize the device.

Initially, the user of the device 2102 sends a request for personalization, which can be sent to the server 2108 of the device via the terminal 2104. After exchanging transaction-related data, such as payment, identification and the like, the server 2108 generates and sends a first key exchange message to the terminal 2104. The device 2102 receives the first key exchange message from the terminal 2104 and generates a second key exchange message based on the first key exchange message. The second key exchange message is sent to the server 2108, directly or indirectly through the terminal 2104, which process is executed through multiple channels. Then, the server 2108 generates one or more symmetric keys based on the first key exchange message and the second key exchange message, and shares the symmetric keys with the device 2102. The above steps can be repeated multiple times depending on the security requirement. The key exchange methods can be a known Diffie-Hellman key exchange algorithm or similar key exchange methods. Furthermore, although QR code scan is shown in the figure, the personalization process can be used in connection with any NFC.

Optionally, the above personalization process can be used to embed a private key to the device 2102 and a public key to the server 2108, which keys can be generated and transferred from an authority different from the server 2108.

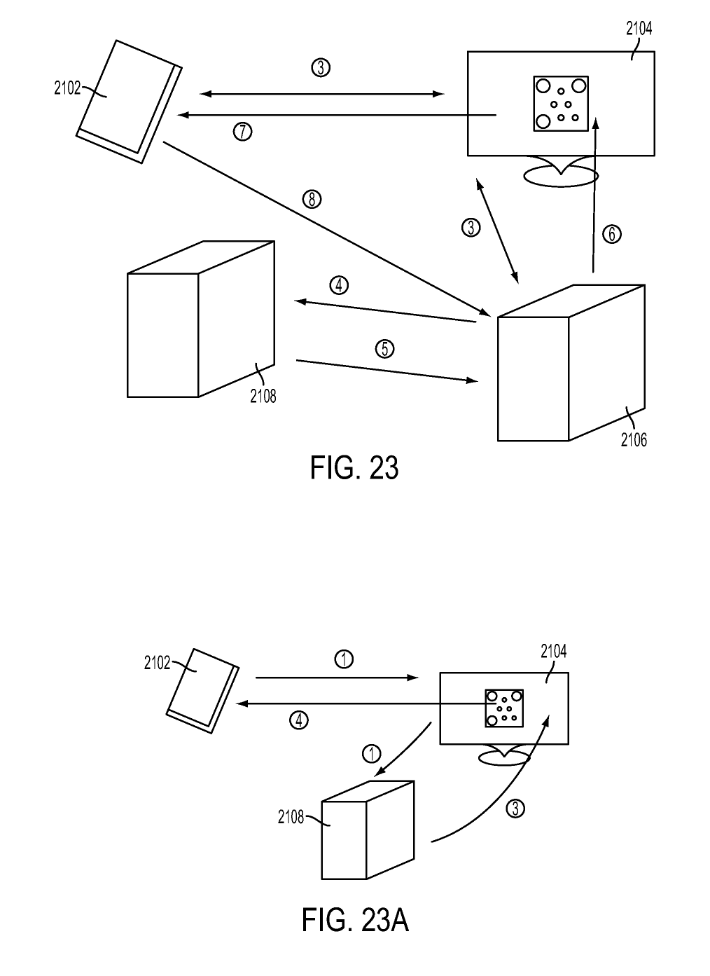

FIG. 23 is a schematic diagram illustrating a binding process of the method, in which the device 2102 and the server 2106 of the service provider are associated to allow the device 2102 and the server 2106 to share one or more symmetric keys.

After personalization, the device 2102 has a unique public name, and confidential information of the device 2102 is shared only with the server 2108 of device. Now, the device 120 needs to bind the server of the service providers, such as the server 2106, after which the device 2102 will have symmetric keys shared with the particular service provider, and this set of symmetric keys are only shared by the device 2102 and the server 2106. The device can bind an arbitrary number of service providers depending on application circumstances. The server 2108 of the device can assist the binding process.

First, the user determines the name to be presented to the service provider. S/he can use the public name of the device, or obtain a one-time anonymous name for the device from the server 2108 of device. If s/he chooses to use the public name or is required to use the public name, there is a potential risk that her/his identity would be revealed. If s/he chooses to use the one-time anonymous name, the service provider would not be able to reveal her/his identity. To use the one-time anonymous name, s/he may follow the steps shown in FIG. 23A, which will be described later.

Next, the user sends a request for binding to the service provider, for example, through the terminal 2104. After exchanging transaction-related information, such as payment, identification and the like, the server 2106 of service provider requests an identifier of the device 2102 (either public name or one-time anonymous name) and one or more OTACs generated by the device 2102. Such information is sent to the server 2106, for example, through the terminal 2104.

The server 2106 of the service provider further sends the information to the server 2108 of the device.

After receiving information from the server 2106 of the service provider, the server 2108 of the device determines the validity of the device 2102. If the device 2102 is validated, the server 2108 sends one or more binding instruction codes to the server 2106 of the service provider.

The server 2106 of the service provider selects its own communication keys and encrypts the keys based on the binding instruction codes. The encrypted keys are sent to the device 2102, for example, through the terminal 2104.

Upon receiving information from the terminal, the device 2102 will conduct a key-generation process based on its symmetric key shared with the server 2108 of the device and the received information, the key generation process including several kinds of decryption and encryption and so on. After the process, the device 2102 shares the symmetric keys with the service provider.

The device 2102 can optionally send a confirmation message back to the server 2106 of the service provider, directly or indirectly through the terminal 2104.

The above steps can be repeated depending on the security requirements.

The binding process is completed after the device 2102 shares symmetric keys with the server 2106 of the service provider. The encryption methods used in the process of transferring information from the server 2106 to the device 2102 can be any strong encryption methods. For example, format-preserving encryption can be used if typing input is needed. In any case, during the process of transferring information from the server 2106 to the device 2102, the communication is safe even though no encryption is implemented.

Optionally, the above process can be used to embed a private key into the device 2102 and a public key into the server 2106 of the service provider. The pair of private and public keys, typically called digital certificate, can be transferred from an authority selected by the service provider.

FIG. 23A illustrates a process for obtaining a one-time anonymous name from the server 2108 of the device, such that the identity of the user remains anonymous to a particular service provider.

Initially, the user sends a request to the server 2108 of the device. After one or more rounds of exchanging transaction-related information, such as payment, authentication and the like, the server 2108 of the device generates a one-time anonymous name for the device and saves it in database. The anonymous name is valid for a predetermined period of time.

The device 2102 receives messages from the server 2108 through the terminal 2104 and processes data according to instructions embedded in the messages. After that, the one-time anonymous name is inserted into the device 2102. The device 2102 can retrieve the anonymous name during a predetermined period of time.

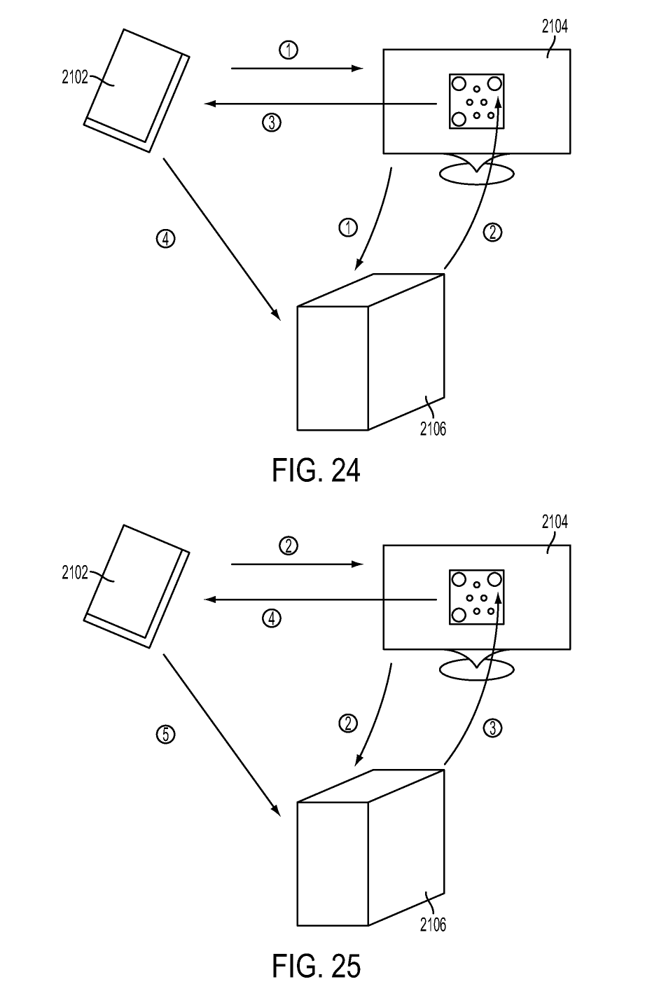

FIG. 24 is a schematic diagram illustrating a process of ID authentication. After successfully binding a service provider, the device 2102 shares confidential information with the service provider, which is properly protected through hardware and software and will not be used externally or transferred in any form.

Initially, the user sends a request of authentication to the server 2106 of the service provider, for example, through the terminal 2104 through a first communication channel.

Upon receiving the request, the server 2106 of the service provider generates and sends an instruction message to the terminal 2104, which contains instructions to the device 2102. The instruction message is sent to the device 2102 through the terminal 2104 through the first communication channel. The first communication channel can be any information communication channel, such as Internet, telephones, specialized network and the like. For example, the server 2106 can generate a QR code and send the code to the terminal 2104; and the device 2102 can read the code from the terminal.

The device 2102 generates a response message based on the instruction message and sends the response message to the server 2106 through a second communication channel, which is different from the first communication channel. For example, the response message can include authentication credentials, such as a user name, a one-time password or conditions for generating the one-time password. For example, the response message can be generated by processing the QR code.

Upon receiving the response message, the server 2106 conducts a multi-channel and multi-factor authentication. The server 2106 can generate an authentication message based on the authentication credentials, and the send the authentication message to the terminal 2104 to activate the terminal. For example, the authentication is conducted based on two factors. Factor 1 indicates that only the user who has the device can generate the message; factor 2 indicates that only the user who knows certain knowledge can generate the message. The authentication is conducted based on multiple channels: one channel between the service provider and the terminal 2104 and the other channel between the device 2102 and the service provider, as shown in FIGS. 19A-19B. If necessary (such as, higher security requirements, doubts of attacks, or intention to update symmetric keys), the steps of generating a response message and sending the response message to the service provider can be repeated.

FIG. 25 is a schematic diagram illustrating a process of transaction control of the method. The device 2102 can have a private key and the service provider can have a public key, which are collectively called a digital certificate. The private/public key algorithms can be applied for transaction control, for example, for managing transaction records, such as digital signatures.

Assuming the transaction is completed after ID authentication, the user sends a request for transaction records. The server 2106 of the service provider sends a form, such as a transaction information form, to the terminal 2104. The user is required to fill the form with transaction information, such as payment to a third party. The user fills the form with transaction-related data and sends it back to the server 2106 through the terminal 2104.

The server 2106 receives the information from the terminal 2104 and conducts an initial determination of validity, and sends back an instruction message to the terminal 2104 to request confirmation.

Upon receiving the instruction message, the device 2102 generates a response message and sends the response message back to the server 2106 through multiple channels.

Once receiving the response message from the device 2102, the server 2106 conducts a 2-factor verification, in which factor 1 indicates that only the user who has the device can generate the message and factor 2 indicates that only the user who knows certain knowledge can generate the message. The verification is conducted through multiple channels: one channel between the service provider and the terminal and the other channel between the device and the service provider.

If necessary (such as higher security requirements, doubts of attacks, or intention to update symmetric keys), the steps of initial determination, generating a response message and sending the response message through multiple channels can be repeated.

If necessary (such as regulatory compliance and the like), in the above steps, the user's digital signatures can be generated and sent to the service provider. For example, at the step of generating a response message, messages based on symmetric keys and/or asymmetric keys can be generated, depending on the service provider's instructions.

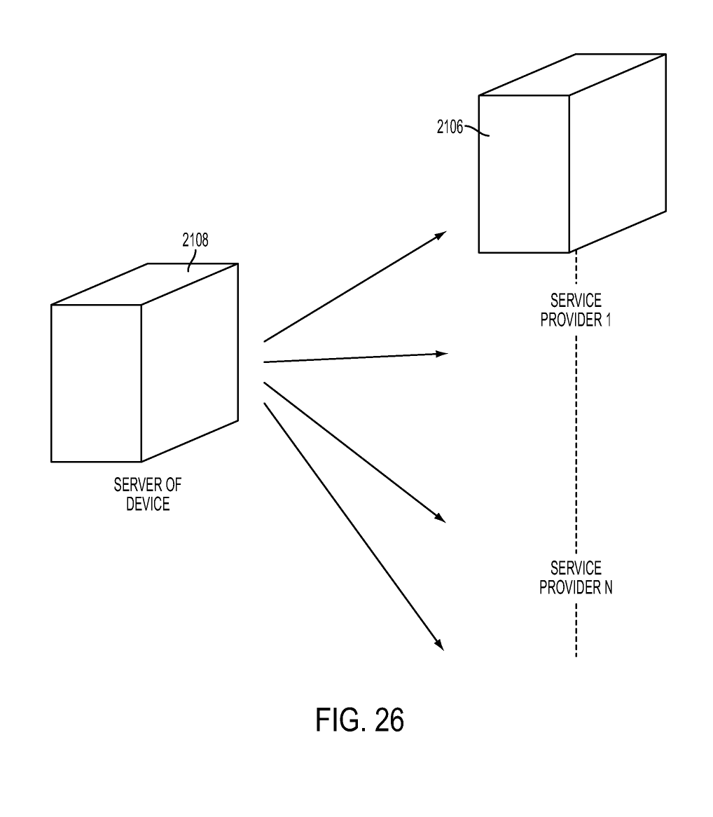

FIG. 26 is a schematic diagram illustrating a process of unbinding the device from the service providers according to the method. Under certain circumstances, for example, the device 2102 is lost or the user of the device intends to stop using the device for all service providers, the unbinding process is required. The unbinding process avoids the tedious process of contacting all service providers individually. The unbinding process further allows the user to temporarily suspend the services.

First, the user sends a request to the server 2108 of the device 2102, for example, through the terminal 2104. At this stage, necessary transaction steps, such as payment transaction and the like, are completed and the ID authentication is completed by back-up methods. At this stage, the server 2108 further determines all the service providers associated with the device or having a record of the device.

The server 2108 then sends unbinding requests to all service providers, with which the device 2102 is associated and of which the server 2108 has records (for anonymous communication, there is no records). Subsequently, the servers of the service providers determine if the unbinding process should be conducted. If so, the servers of the service providers disassociate the device 2102 through their respective servers to terminate sharing the symmetric keys with the device 2102.

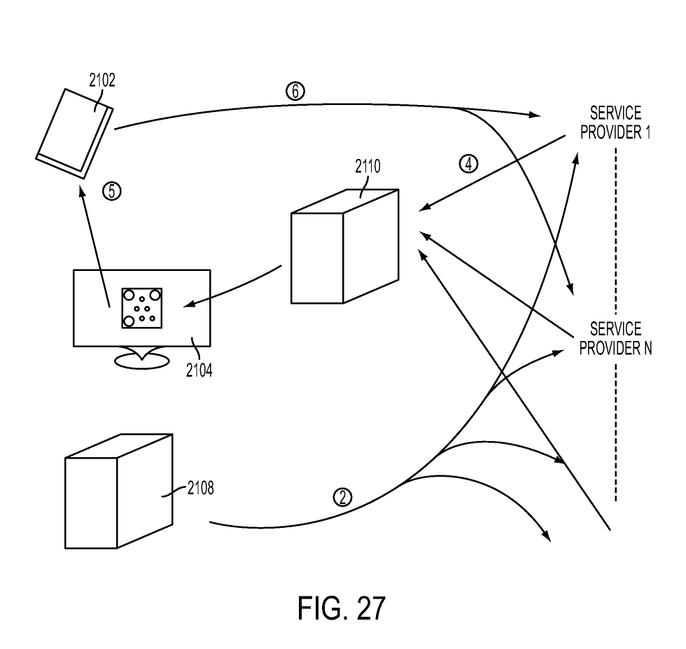

FIG. 27 is a schematic diagram illustrating a process of rebinding the device with one or more service providers, according to an aspect of the method. For example, the user has lost her/his device and unbounded the device from all service providers to ensure that no further transaction can be made. S/he later obtains a new device and intends to bind the device with all the previous service providers. By means of the rebinding process, the user can rebind the device with all service providers simultaneously.

Initially, the user selects a terminal (such as the terminal 2104), through which the rebinding process can be conducted. Through the terminal, the user sends a request for rebinding to the server 2108 of the device. After necessary steps (such as payment transaction and the like) and authentication by back-up methods (since the user has no previous device anymore), the personalization process will be conducted to allow the device 2102 and the server 2108 to share a set of symmetric keys, which can be same as or different from the previous symmetric keys for personalization prior to the unbinding process.

After personalization, the process of rebinding all previous service providers begins. The server 2108 of the device 2102 sends rebinding requests to all service providers, with which the device is associated and of which the server 2102 maintains a record (for anonymous communication, there is no records). The servers of the service providers determine if the rebinding process would be conducted.

If the service providers determine to rebind, the servers thereof perform the binding steps shown in FIG. 23, and generate encrypted information. This information is sent to a common service computer 2110. Similarly, all service providers send information to the same service computer 2110. After receiving all the information from the service providers, the service computer sends a notification to the server 2108 of the device and the server 2108 sends a corresponding notification to the device 2102.

After receiving the notification from the server 2108, the user communicates with the service computer 2110 through the terminal 2104. For example, all rebinding information is shown on the terminal. Subsequently, all rebinding information is acquired by the device 2102 for processing, which results in sharing a set of symmetric keys between the device 2102 and the servers of the service providers. The user can further send a confirmation message back to the servers of the service providers. In one embodiment, the above steps are conducted through multiple channels.

The system and method according to an aspect of the present disclosure is capable of conducting the steps of personalizing a handheld electronic device, binding the device with any selected service provider, ID authenticating with any service provider, controlling transaction with any service provider, remaining anonymous of the device to any service provider during the authentication and transaction control, collectively unbinding the device from the service providers (for example, in case of device loss), and collectively rebinding the device with all the service providers.

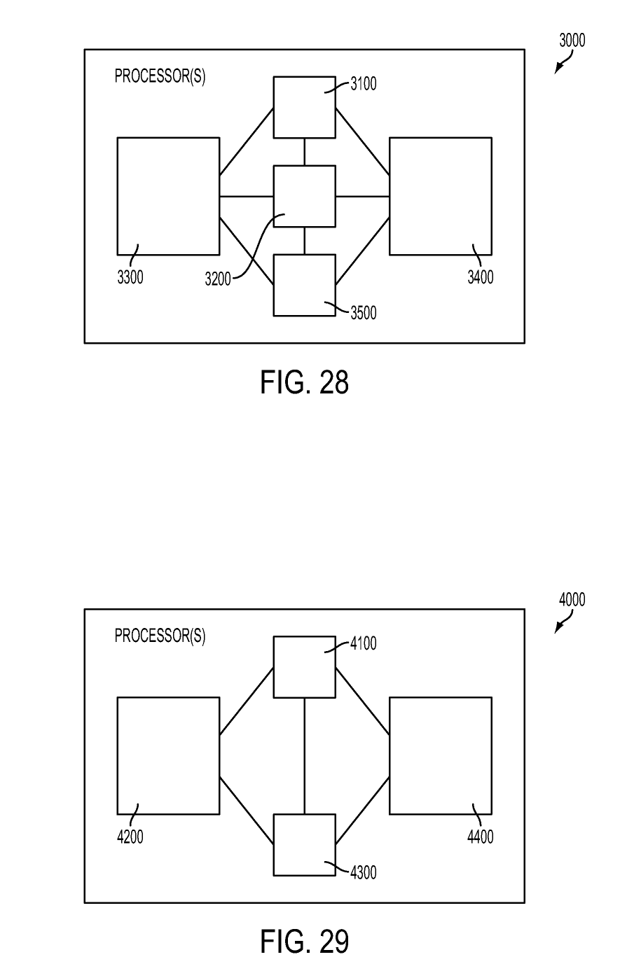

FIG. 28 illustrates a data processing system 3000 according to another aspect of the disclosure. The system 3000 is used in connection with the device 2102 for conducting a multi-factor and multi-channel ID authentication or transaction control. The system 3000 includes a personalizing module 3100, a binding module 3200 and a processing module 3500, which communicate with a transmitting module 3300 and a receiving module 3400. The personalizing module 3100 is configured to personalize the device 2102 and the server 2108 of the device, to allow the device and the server to share one or more symmetric keys. The binding module 3200 is configured to bind the device 2102 with the server 2106 of the service provider to allow the device and the server 2106 to share the symmetric keys. The transmitting module 3300 is configured to send messages to external devices, such as, a request for ID authentication or transaction control to the server 2106. The receiving module is configured to receive messages from external devices, such as, an instruction message from the server 2106 of the service provider. The processing module 3500 is configured to generate a response message based on the received instruction message. The response message is sent to the server 2106 of the service provider for conducting a multi-channel and multi-factor ID authentication or transaction control. The system 3000 may include one or more processors or the like for executing one or more of the modules of the system 3000.

FIG. 29 illustrates a data processing system 4000 according to another aspect of the disclosure. The system 4000 is used in connection with the server 2106 of the service provider for conducting a multi-factor and multi-channel ID authentication and/or transaction control. The system 4000 includes a binding module 4100 and a processing module 4300, which communicate with a receiving module 4200 and a transmitting module 4400. The binding module 4100 is configured to bind the server 2106 to the device 2102 to allow the server and the device to share one or more symmetric keys, the symmetric keys being shared between the device 2102 and the server 2108 of the device 2102. The receiving module 4200 is configured to receive messages from external devices, such as, a request for ID authentication or transaction control from the device 2102. The processing module 4300 is configured to generate an instruction message upon receiving the request from the device. The transmitting module 4400 is configured to send messages to external devices, such as, the instruction message to the device 2102. A response message, generated by the device 2102 based on the instruction message, is received by the receiving module 4200. The processing module 4300 is further configured to conduct a multi-channel and multi-factor ID authentication or transaction control of the device based on the received response message. The system 4000 may include one or more processors or the like for executing one or more of the modules of the system 4000.

All these processes are conducted in a multi-factor and multi-channel manner. In one embodiment of the present disclosure, except the steps of personalizing, binding, unbinding and rebinding, the steps of ID authenticating and transaction controlling may be conducted solely between the device and the service providers, with no involvement of a third party. Thus, a centralized server during the ID authentication and transaction control is not required. The centralized server renders the entire system hard to adjust and expensive to operate and undermines the service providers' management of the customers' information and privacy. The server of the device is only needed to assist the binding, unbinding and rebinding processes, during which the users' IDs are properly protected, such as by being kept anonymous. The exemplary embodiments of the present disclosure offer advantages at least partly in that no third part is consistently required during the ID authentication and transaction.

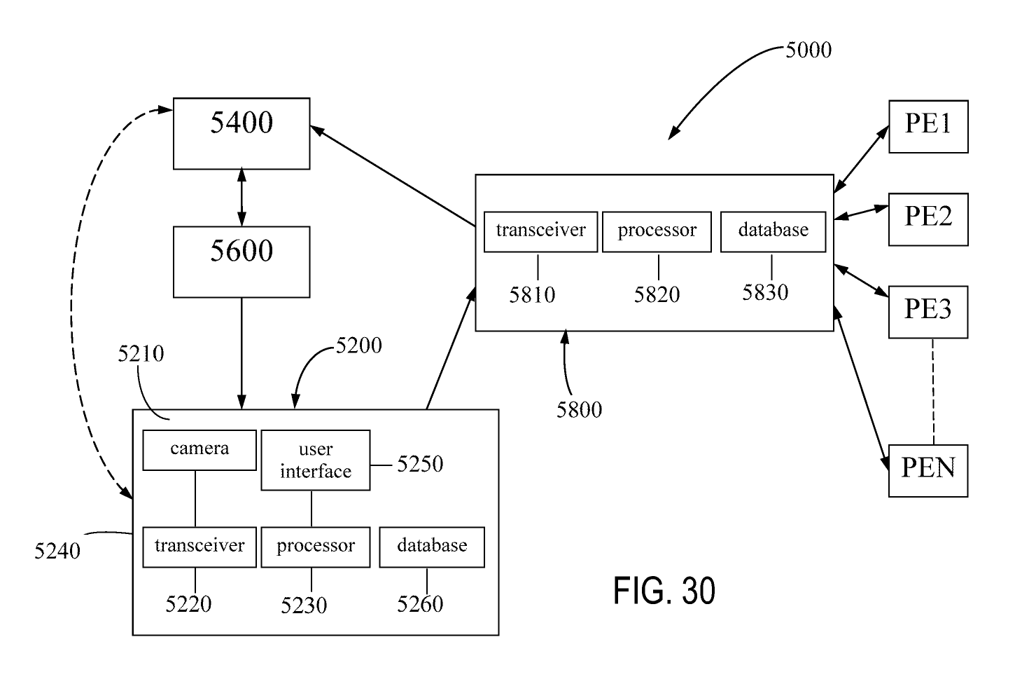

FIG. 30 is a block diagram of a payment system 5000 according to an exemplary embodiment of the disclosure. The payment system 5000 includes an electronic device 5200, which is typically a hand-held electronic device used by an individual purchaser. The electronic device 5200 includes, but is not limited to, hardware and/or software components embodied in hardware, such as a cell phone or smart phone with specialized software. For example, the electronic device 5200 can further provide functionalities of scanning, networking, showing barcode, performing Near Field Communication (NFC) and so on.

During an electronic transaction, the electronic device 5200 communicates with a server 5400 of a merchant that sells items to its customers. The electronic device 5200 can communicate with servers of a plurality of merchants, for example, through multi-channel communications. The authentication of the electronic device 5200 and the transaction control between the device 5200 and the server 5400 has been discussed previously.

The server 5400 of the merchant includes, but is not limited to, a computer, a processor and the like, which is capable of maintaining database and implementing predetermined algorithms. The merchant can be, for example, an on-line selling site, such as eBay® or Amazon®. After the purchaser selects one or more items and places an order for the selected item(s), the server 5400 of the merchant generates a code, such as a Quick Response (QR) code, and sends the code through a first communication channel to a terminal 5600. The channel can be any information communication channel, such as Internet, specialized network and the like. The code is formed based on transaction-related information and merchant information. The transaction-related information includes, but is not limited to, the identification of the selected item(s), the price of the selected item(s), the recipient of the selected item(s), the delivery address of the selected item(s), the recipient of a confirmation message after delivery and the like. The merchant information includes, but is not limited to, one or more identification of the merchant, description of the merchant, and a signature with symmetric key of the merchant and a payment portal (which will be described later).

The terminal 5600 includes, but is not limited to, hardware and/or software components embodied in hardware. For example, the terminal 5600 can be a computer with a web browser or similar user interface, a Point Of Sale (POS) machine, and the like. For example, the communication between the electronic device 5200 and the terminal 5600 can be a scan-in communication, through which the QR code is scanned from the terminal into the handheld electronic device 5200 by a camera 5210 of the electronic device 5200.

The electronic device 5200 includes a transceiver 5220, which receives the QR code scanned by the camera 5210 and transfers the code to a processor 5230. The processor 5230 processes the QR code to retrieve the transaction-related information and display the transaction-related information on a display screen 5240. The transaction-related information includes, but is not limited to, the identification of the selected item(s), the price of the selected item(s), the recipient of the selected item(s), the delivery address of the selected item(s), the recipient of a confirmation message after delivery and the like. The retrieved information can be in the form of text or code, as long as the information is apprehensible to the purchaser. For example, the retrieved information is displayed on the display screen 5240, for the purchaser to visually validate the transaction-related information, such that the transaction-related information of the commodity intended by the purchaser can be validated.

If the purchaser determines that all of the transaction-related information is accurate and determines to proceed with payment of the selected item(s), the purchaser can initiate the payment process, for example, by touching a button displayed on the screen 5240. Optionally, the purchaser can initiate the payment process by inputting certain special designed codes or performing a biometric input, such that it can be ensured that the selected item(s) is intended by the purchaser and that an additional layer of security can be incorporated. In response, a user interface 5250 is displayed on the screen 5240 for the purchaser to select a payment option from a plurality of predetermined payment options. For example, the payment option includes, but is not limited to, credit card payment, debit card payment, third party payment, bank transfer payment, small amount account payment and the like. Based on the transaction information and the selected payment option, the processor 5230 generates a payment message, which comprises a first segment and a second segment.

The first segment includes information related to the selected payment option, and the second segment includes information related to the purchaser's account data associated with the selected payment option. For example, if the purchaser has selected the credit card payment option, the first segment of the payment message is generated to have an identifier corresponding to credit card payment option and the second segment is generated to indicate the purchaser's credit card account, which has been previously saved in database 5260.

The payment message is sent to a payment portal 5800 through the transceiver 5220. The communication between the device 5200 and the payment portal 5800 is through a second communication channel. The multi-channel communication methods have been discussed previously. For example, the second communication channel is different from the first communication channel between the server 5400 of the merchant and the electronic device 5200. The portal 5800 includes, but is not limited to, a computer and the like, which is capable of maintaining database and implementing predetermined algorithms. The portal 5800 is in communication with the servers of a plurality of Participating Entity (PE), such as PE 1 through PE N. Each of the participating entity is associated with at least one of the plurality of predetermined payment options. For example, the participating entity can be any suitable participating financial institutions, such as banks, credit card companies, third party payment institutions, small amount account payment institutions and the like. For example, PE 1 is a credit card company, PE 2 is a bank and PE 3 is third party payment institution.

The portal 5800 receives the payment message through a transceiver 5810. The transceiver 5810 sends the payment message to a processor 5820. Based on the first segment of the payment message, the processor 5820 selects an appropriate participating entity associated with the selected payment option. For example, the processor 5820 retrieves the identifier from the first segment and compares the identifier with the identifiers of the participating entities stored in database 5830, to select a participating entity associated with the selected payment option. For example, if the selected payment option is a credit card payment option, the processor 5820 selects PE 1, which is a credit card company associated with purchaser.

Once the participating entity has been selected, the processor 5820 instructs the transceiver 5810 to send the second segment of the payment message to the participating entity. After authentication of the portal 5800, the selected participating entity processes the second segment of the payment message to determine if the purchaser's account associated with the selected payment option is valid. If the account is valid, the selected participating entity generates an instruction message indicating that the payment will be made through the purchaser's selected payment option. Otherwise, the selected participating generates an instruction message indicating that the payment cannot be made through the purchaser's selected payment option.

The portal 5800 receives the instruction message through the transceiver 5810 and further sends the instruction message to the server 5400 of the merchant through a third communication channel. For example, the third communication channel is different from the first communication channel between the server 5400 of the merchant and the electronic device 5200 and the second communication channel between the electronic device 5200 and the payment portal 5800. For example, after the server 5400 of the merchant receives the instructions message, the money transfer will occur at a clearinghouse.

The authentication between the electronic device 5200 and the portal 5800 is described as following. The payment message includes a first sub-message MPO1 intended for the payment portal 5800 and a second sub-message MPE intended for a PE associated with the payment portal. Based on the first sub-message MPO1, the portal 5800 authenticates the electronic device 5200 and, if the authentication is successful, the portal 5800 sends the second sub-message MPE to the PE. The first sub-message MPO1 is formed based on the transaction-related information of the commodity, the merchant description, the PE-related information (such as information related to a bank), a signature with symmetric keys of the electronic device and the portal, and a unique identifier of the purchaser. The second sub-message MPE is formed based on the merchant description, PE-related information, encryption of the purchaser's account information associated with the PE and, optionally, a digital signature of the purchaser (if it is required by the PE).

For the authentication of the electronic device 5200, several symmetrical keys are established between the electronic device 5200 and the portal 5800, the process of which has been discussed previously. The symmetrical keys are the basis for conducting a 2-factor authentication. In addition, the purchaser can have a unique identifier, such as a password or a fingerprint, which is not shared with the portal. The purchaser's account information associated with the PE can be encrypted by a public key of the PE or encrypted through other known methods preferred by the PE.

Optionally, the electronic device 5200 and the PE can also share the symmetric keys. The establishment of shared symmetric keys has been discussed previously. The digital signature in the second sub-message of the payment message is typically obtained by public-private key pairs. However, the digital signature can be obtained through other known methods preferred by the PE.

The instruction message sent from a PE to the server 5400 of the merchant through the portal 5800 includes a payment agreement message, which includes a first sub-message MPO2 intended for the portal 5800 and a second sub-message MME intended for the server 5400 of the merchant. During the communication, the portal 5800 authenticates the PE based on the first sub-message MPO2. If the authentication is successful, the portal 5800 sends the second sub-message MME and the first sub-message of the payment message MPO1 to the server 5400 of the merchant. The second sub-message MME is formed based on the description of the merchant, the purchaser-related information, PE-related information, payment-related information, payment agreement, and a signature of the PE. The first sub-message MPO2 is formed based on a signature with symmetric keys shared between the PE and the portal 5800. The establishment of shared symmetric keys between the PE and the portal 5800 has been discussed previously.

The transceiver 5220, the processor 5230, the user interface 5250 and the database 5260 can be incorporated into a data processing system, which is used in connection with the electronic device 5200. The transceiver 5810, the processor 5820 and the database 5830 can be incorporated into a data processing system, which is used in connection with the payment portal.

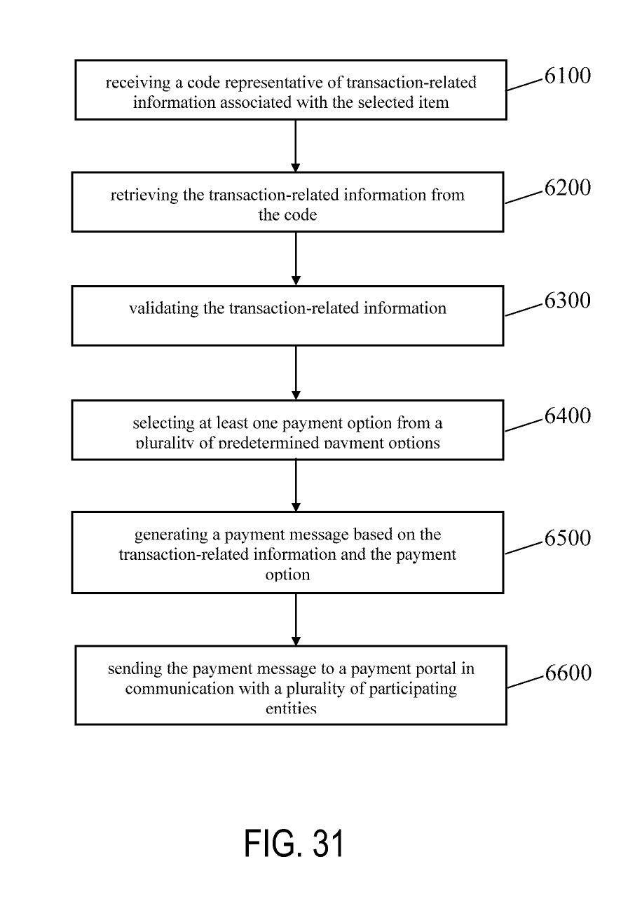

FIG. 31 is a flowchart illustrating a method of allowing a purchaser to use an electronic device to execute the payment of one or more selected items from a merchant, according to an embodiment of another aspect of the present disclosure.

At step 6100, a code representative of transaction-related information associated with the selected item(s) is received by the electronic device. At step 6200, the transaction-related information is retrieved from the code. At step 6300, the transaction-related information is validated. At step 6400, at least one payment option is selected from a plurality of predetermined payment options. At step 6500, a payment message is generated based on the transaction-related information and the payment option. The payment message comprises a first segment indicating the payment option and a second segment indicating the purchaser's account data associated with the payment option. At step 6600, the payment message is sent to a payment portal in communication with a plurality of participating entities. Each of the participating entities is associated with at least one of the plurality of predetermined payment options.

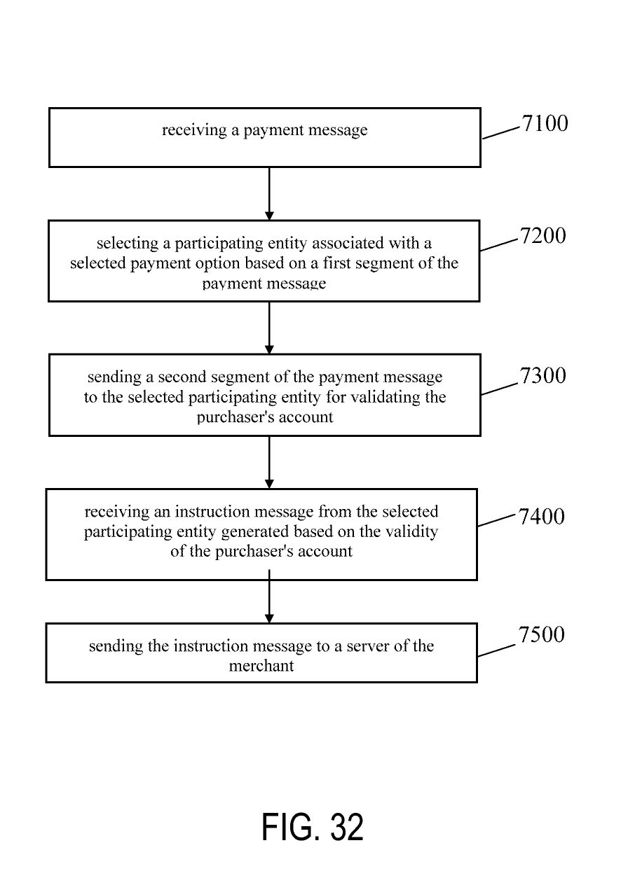

FIG. 32 is a flowchart illustrating a method of allowing a purchaser to execute the payment of one or more selected items from a merchant through a payment portal in communication with a plurality of participating entities, according to an embodiment of another aspect of the present disclosure. Each one of the participating entities is associated with at least one of a plurality of predetermined payment options.

At step 7100, a payment message is received by the payment portal. The payment message comprises a first segment indicating a payment option selected by the purchaser from the plurality of predetermined payment options and a second segment indicating the purchaser's account data associated with the selected payment option. At step 7200, a participating entity associated with the payment option is selected based on the first segment of the payment message. At step 7300, the second segment of the payment message is sent to the selected participating entity for validating the purchaser's account associated with the selected payment option. At step 7400, an instruction message, generated based on the validity of the purchaser's account, is received from the selected participating entity. At step 7500, the instruction message is sent to a server of the merchant.

The embodiments of the present disclosure provide certain advantages. For example, the purchaser's account information is saved and selected at the electronic device, rather than being saved at the payment portal, which renders a more secure electronic payment system. Furthermore, the portal has the capacity of expanding its connection with a number of participating entities. Therefore, the purchasers have a plurality of payment options.

Various aspects of the present disclosure may be embodied as a program, software, or computer instructions embodied in a computer or machine usable or readable medium, which causes the computer or machine to perform the steps of the method when executed on the computer, processor, and/or machine. A program storage device readable by a machine, tangibly embodying a program of instructions executable by the machine to perform various functionalities and methods described in the present disclosure is also provided.

The system and method of the present disclosure illustrated above may be implemented and run on a general-purpose computer or special-purpose computer system. The computer system may be of any type of known or will be known systems and may typically include a processor, memory device, a storage device, input/output devices, internal buses, and/or a communications interface for communicating with other computer systems in conjunction with communication hardware and software and so on.

A computer program product may include any tangible or physical medium that can store data and/or computer instructions, and, for example, that can be read and/or be executed by a computer, machine or the like. Examples may include but are not limited to, memory devices (such as a random access memory (RAM), a read-only memory (ROM) and the like), discs, optical storage devices, and others.

The terms “computer system” and “computer network” as may be used in the present disclosure may include a variety of combinations of fixed and/or portable computer hardware, software, peripherals, and storage devices. The computer system may include a plurality of individual components that are networked or otherwise linked to perform collaboratively, or may include one or more stand-alone components. The hardware and software components of the computer system of the present application may include and may be included within fixed and portable devices such as a desktop, a laptop or a server. A module may be a component of a device, software, program, or system that implements some “functionality”, which can be embodied as software, hardware, firmware, electronic circuitry, or etc.

The embodiments described above are illustrative examples and it should not be construed that the present disclosure is limited to these particular embodiments. Thus, various changes and modifications may be effected by one skilled in the art without departing from the spirit or scope of the disclosure as defined in the appended claims.

What is claimed is:

1. A method of allowing a purchaser to use an electronic device to execute the payment of a selected item from a merchant, the method comprising:
receiving a code representative of transaction-related information associated with the selected item;
retrieving the transaction-related information from the code;
validating the transaction-related information;
selecting at least one payment option from a plurality of predetermined payment options;
generating a payment message based on the transaction-related information and the payment option, the payment message comprising a first segment indicating the payment option and a second segment indicating the purchaser's account data associated with the payment option; and
sending the payment message to a payment portal in communication with a plurality of participating entities, each of said participating entities being associated with at least one of the plurality of predetermined payment options.

2. The method of claim 1, wherein the receiving the code representative of transaction-related information associated with the selected item comprises scanning the code displayed on a terminal in communication with a server of the merchant.

3. The method of claim 1, wherein the transaction-related information associated with the selected item comprises the identification of the selected item, the price of the selected item, the recipient of the selected item, the delivery address of the selected item and the recipient of a confirmation message after delivery.

4. The method of claim 1, wherein the plurality of predetermined payment options comprise credit card payment, debit card payment, third party payment, bank transfer payment and small amount account payment.

5. The method of claim 1, wherein the plurality of participating entities comprise banks, credit card companies, third party payment institutions and small amount account payment institutions.

6. A method of allowing a purchaser to execute the payment of a selected item from a merchant through a payment portal in communication with a plurality of participating entities, each participating entity associated with at least one of a plurality of predetermined payment options, the method comprising:
receiving a payment message comprising a first segment indicating a payment option selected by the purchaser from the plurality of predetermined payment options and a second segment indicating the purchaser's account data associated with the selected payment option;
selecting a participating entity associated with the selected payment option based on the first segment of the payment message;
sending the second segment of the payment message to the selected participating entity for validating the purchaser's account associated with the selected payment option;
receiving an instruction message from the selected participating entity, the instruction message generated based on the validity of the purchaser's account; and
sending the instruction message to a server of the merchant.

7. The method of claim 6, wherein the plurality of predetermined payment options comprise credit card payment, debit card payment, third party payment, bank transfer payment and small amount account payment.

8. The method of claim 6, wherein the plurality of participating entities comprise banks, credit card companies, third party payment institutions and small amount account payment institutions.

9. A computer program product for use with a computer, the computer program product comprising a computer readable storage medium having recorded thereon a computer-executable program for causing the computer to perform a process of allowing a purchaser to use an electronic device to execute the payment of a selected item from a merchant, the process comprising:
receiving a code representative of transaction-related information associated with the selected item;
retrieving the transaction-related information from the code;
validating the transaction-related information;
selecting at least one payment option from a plurality of predetermined payment options;
generating a payment message based on the transaction-related information and the payment option, the payment message comprising a first segment indicating the payment option and a second segment indicating the purchaser's account data associated with the payment option; and
sending the payment message to a payment portal in communication with a plurality of participating entities, each of said participating entities being associated with at least one of the plurality of predetermined payment options.

10. A data processing system for allowing a purchaser to use an electronic device to execute the payment of a selected item from a merchant, the system comprising:
a transceiver configured to receive a code representative of transaction-related information associated with the selected item;
a processor configured to retrieve the transaction-related information from the code;
a display configured to display the transaction-related information, such that the transaction-related information can be validated by the purchaser; and
a user interface configured to allow the purchaser to select a payment option from a plurality of predetermined payment options;
wherein the processor is further configured to generate a payment message based on the transaction-related information and the payment option, the payment message comprising a first segment indicating the payment option and a second segment indicating the purchaser's account data associated with the payment option; and
wherein the transceiver is further configured to send the payment message to a payment portal in communication with a plurality of participating entities, each of said participating entities being associated with at least one of the plurality of predetermined payment options.

11. A computer program product for use with a computer, the computer program product comprising a computer readable storage medium having recorded thereon a computer-executable program for causing the computer to perform a process of allowing a purchaser to execute the payment of a selected item from a merchant through a portal in communication with a plurality of participating entities, each participating entity associated with at least one of a plurality of predetermined payment options, the process comprising:
receiving a payment message comprising a first segment indicating a payment option selected by the purchaser from the plurality of predetermined payment options and a second segment indicating the purchaser's account data associated with the selected payment option;
selecting a participating entity associated with the selected payment option based on the first segment of the payment message;
sending the second segment of the payment message to the selected participating entity for validating the purchaser's account associated with the selected payment option;
receiving an instruction message from the selected participating entity, the instruction message generated based on the validity of the purchaser's account; and
sending the instruction message to a server of the merchant.

12. A data processing system for allowing a purchaser to execute the payment of a selected item from a merchant through a portal in communication with a plurality of participating entities, each participating entity associated with at least one of a plurality of predetermined payment options, the system comprising:
a transceiver configured to receive a payment message comprising a first segment indicating a payment option selected by the purchaser and a second segment indicating the purchaser's account data associated with the selected payment option; and
a processor configured to select a participating entity associated with the selected payment option based on the first segment of the payment message;
wherein the transceiver is further configured to send the second segment of the payment message to the selected participating entity for validating the purchaser's account, receive an instruction message generated based on the validity of the purchaser's account from the selected participating entity, and send the instruction message to a server of the merchant.
